(19) United States
(12) Patent Application Publication
(10) Pub. No.: US 2026/0367041 A1
(43) Pub. Date: Nov. 19, 2026

(54) ASSEMBLIES, APPARATUSES, AND METHODS PROVIDING ENHANCED AUTOMATED NON-DESTRUCTIVE INSPECTION OF COMPONENTS

(71) Applicants: Jeong-Kwan Na, Centerville, OH (US); William Charles Quinn, Fairborn, OH (US); Andrew Robert Betts, Bellbrook, OH (US); Thomas Paul DeWalt, Moore, OK (US); Cassandra Lynn Chesna, Edmond, OK (US); Dennis Keith Alexander, Jr., Huber Height, OH (US)

(72) Inventors: Jeong-Kwan Na, Centerville, OH (US); William Charles Quinn, Fairborn, OH (US); Andrew Robert Betts, Bellbrook, OH (US); Thomas Paul DeWalt, Moore, OK (US); Cassandra Lynn Chesna, Edmond, OK (US); Dennis Keith Alexander, Jr., Huber Height, OH (US)

(73) Assignee: KBR Wyle Services LLC, Houston, TX (US)

(21) Appl. No.: 19/675,115

(22) Filed: May 12, 2026

Related U.S. Application Data
(60) Provisional application No. 63/805,450, filed on May 14, 2025.

(51) Int. Cl. G01N 29/04; G01N 29/265; G01N 29/28

(52) U.S. Cl. CPC G01N 29/043; G01N 29/041; G01N 29/265; G01N 29/28; G01N 2291/044

(57) ABSTRACT

Assemblies, apparatuses, and methods providing enhanced non-destructive inspection of components may include a crack detection assembly for automated non-destructive inspection of a component. The crack detection assembly may include an ultrasonic transducer to emit an ultrasonic signal into a surface of the component and receive a return signal reflected from the surface of the component. A transducer fixture coupled to the transducer may include a fixture base, the fixture base being substantially planar and configured to approach the surface of the component when emitting the ultrasonic signal and receiving the return signal. The transducer fixture further may include a fixture transducer mount to which the transducer is coupled, such that the ultrasonic signal is emitted at an angle relative to the component. The transducer fixture also may include a front face having a cross-section configured to at least partially collimate the ultrasonic signal.

### CROSS REFERENCE TO RELATED APPLICATION

This application claims priority to U.S. Provisional Patent Application having Ser. No. 63/805,450 filed on May 14, 2025 which is incorporated by reference herein.

### TECHNICAL FIELD

The present disclosure relates to assemblies, apparatuses, and methods providing enhanced non-destructive inspection of components and, more particularly, to assemblies, apparatuses, and methods providing enhanced automated non-destructive inspection of components.

### BACKGROUND

The prolonged operation of many machines may increase the risk of the failure of components of the machine. For some types of machines and components, such failures may be unacceptable. For example, aircraft, civilian and military, include many components for which the risk of component failure may be unacceptable, and thus, it may be desirable to mitigate such risk. One aspect of the aging process from prolonged operation involves the formation of surface-breaking fatigue cracks at stress concentration areas of critical components, such as rotating rotors and turbines of aircraft jet engines. It may be important to detect such fatigue cracks as soon as possible, for example, before the cracks enlarge and cause failure of the component. For example, for jet engines, critical sections of stress concentration areas may be routinely inspected according to pre-established maintenance procedures. In some instances, inspection of such areas may require significant time for non-destructive inspection with highly sophisticated robotic systems equipped with various sizes and types of custom-designed eddy current probes. With an eddy current probe, an active coil section of the probe must directly interact with the surface area being inspected in order to produce a reliable inspection result. Some critical areas may involve complex three-dimensional surface contours, requiring movement of the probe in multi-axial motions to inspect a desired area of inspection. In many instances, the physical dimensions of surface contours of a component are highly repeatable from one location to another on the component due to narrow manufacturing tolerances. In such instances, the movement of the probe across the component may be adequately controlled via preprogrammed probe holders, such as, for example, robotic mechanisms, from start to finish to adequately inspect an entire area desired to be inspected.

Recent changes in the manufacturing processes of modern components, such as jet engine components including integrally bladed rotors (IBRs), may result in dimensionally inconsistent component surfaces. For example, blade run-out areas of jet engine components may have complex surface geometries resulting from manual blending surface finishing processes. When such components have a high degree of dimensional variation, it may be challenging to program the motion of the probe, such as inspection robots, to compensate for dimensional inconsistencies with a three-dimensional scanning strategy required to produce reliable inspection results. For example, dimensional variations in surface contours may cause a high level background noise in detected eddy current signals of the probe due to undesirably large air gaps, sometimes referred to as “lift-off” signals. Such geometrically induced high levels of background noise may render inspection results less accurate, less consistent, and/or unreliable.

For at least these reasons, Applicant has recognized that it may be desirable to provide assemblies, apparatuses, and methods providing enhanced non-destructive inspection of components that produce relatively more accurate results, relatively more consistent results, and/or relatively more reliable results. At least some examples described herein may address one or more of the above-noted potential issues, as well as possibly others.

### SUMMARY

As referenced above, it may be desirable to provide assemblies, apparatuses, and methods providing enhanced non-destructive inspection of components that produce relatively more accurate results, relatively more consistent results, and/or relatively more reliable results. In some embodiments, the assemblies, apparatuses, and methods presented herein may provide enhanced non-destructive inspection of components that produces relatively more accurate results, relatively more consistent results, and/or relatively more reliable results. For example, in some embodiments, an ultrasonic signal may be emitted toward the surface of a component being inspected, and a return signal reflected from the surface of the component may be used to determine whether a crack exists in the surface of the component. In some embodiments, the assemblies, apparatuses, and methods presented herein may provide more accurate, more consistent, and/or more reliable results, for example, during inspection of components having irregular or inconsistent physical three-dimensional surface geometries. In some embodiments, the assemblies, apparatuses, and methods presented herein may be used in combination with robotic mechanisms, such as, for example, robotic arms, including, in some embodiments, robotic arms preprogrammed to move an ultrasonic transducer according to an inspection strategy designed to inspect a predetermined area of a component being inspected.

According to some embodiments, a crack detection assembly for automated non-destructive inspection of a component may include an ultrasonic transducer configured to emit an ultrasonic signal into a surface of the component and receive a return signal reflected from the surface of the component. The assembly further may include a transducer fixture coupled to the ultrasonic transducer. The transducer fixture may be substantially transparent to the ultrasonic signal and the return signal. The transducer fixture may include a fixture base, the fixture base being substantially planar and configured to approach the surface of the component when emitting the ultrasonic signal and receiving the return signal. The transducer fixture further may include a fixture transducer mount, the ultrasonic transducer being coupled to the fixture transducer mount, such that the ultrasonic signal is emitted at a mount angle relative to the fixture base, the mount angle being oblique relative to the fixture base. The transducer fixture also may include a fixture front face extending away from the fixture base, the fixture front face having a cross-section substantially parallel to the fixture base, the cross-section being at least partially V-shaped, thereby to at least partially collimate the ultrasonic signal.

According to some embodiments, a crack detection assembly for automated non-destructive inspection of a component may include an ultrasonic transducer configured to emit an ultrasonic signal into a surface of the component and receive a return signal reflected from the surface of the component The ultrasonic transducer may include a piezoelectric element. The piezoelectric element may include a wafer at least partially defined by a first side, a second side opposite the first side, and four edges at a perimeter of the wafer. The first side may have a first conducting coating, and the second side may have a second conducting coating. Three of the four edges may be substantially devoid of conducting coating, and a fourth edge of the four edges may have a conducting coating tab extending from the first side, traversing the fourth edge, and onto the second side. The conducting coating tab may be spaced from the second conducting coating. The assembly further may include a transducer fixture coupled to the ultrasonic transducer, the transducer fixture being substantially transparent to the ultrasonic signal and the return signal.

According to some embodiments, a crack detection assembly for automated non-destructive inspection of a component may include an ultrasonic transducer configured to emit an ultrasonic signal into a surface of the component and receive a return signal reflected from the surface of the component. The assembly further may include a transducer fixture coupled to the ultrasonic transducer, the transducer fixture being substantially transparent to the ultrasonic signal and the return signal. The assembly also may include a couplant supply apparatus coupled to the transducer fixture and configured to supply couplant to the transducer fixture. The couplant supply apparatus may include a couplant reservoir configured to contain a supply of the couplant, and a couplant valve between the couplant reservoir and a couplant passage at least partially defined by the transducer fixture. The couplant valve may be configured to open and close to control flow of the couplant to the transducer fixture.

According to some embodiments, a transducer fixture for a crack detection assembly for automated non-destructive inspection of a component may include a fixture body including a fixture material substantially transparent to ultrasonic signals, and a fixture base. The fixture base may be substantially planar and configured to approach the surface of a component when emitting the ultrasonic signal and receiving the return signal. The transducer fixture further may include a fixture transducer mount configured to be coupled an ultrasonic transducer, such that an ultrasonic signal emitted by an ultrasonic transducer coupled to the fixture transducer mount is emitted in a direction oblique relative to the fixture base. The transducer fixture also may include a fixture front face extending away from the fixture base, the fixture front face having a cross-section substantially parallel to the fixture base. The cross-section may be V-shaped, thereby to at least partially collimate the ultrasonic signal.

According to some embodiments, a piezoelectric transducer for a crack detection assembly for automated non-destructive inspection of a component may include a wafer at least partially defined by a first side, a second side opposite the first side, and four edges at a perimeter of the wafer. The wafer further may include a first conducting coating on the first side and a second conducting coating on the second side. Three of the four edges may be substantially devoid of conducting coating. The wafer also may include a conducting coating tab on a fourth edge of the four edges, the conducting coating tab extending from the first conducting coating on the first side, traversing the fourth edge, and extending onto the second side. The conducting coating tab may be spaced from the second conducting coating on the second side.

According to some embodiments, a couplant supply apparatus for supplying couplant to a crack detection assembly for automated non-destructive inspection of a component may include a couplant reservoir configured to contain a supply of the couplant and a delivery conduit coupled to the couplant reservoir and configured to be coupled to a transducer fixture, thereby to provide fluid flow between the couplant reservoir and the transducer fixture. The apparatus further may include a couplant valve between the couplant reservoir and a couplant passage in the transducer fixture, the couplant valve being configured to open and close to control flow of the couplant to the couplant recess.

According to some embodiments, a method for automated non-destructive inspection of a component may include emitting via a transducer an ultrasonic signal toward a surface of the component at an oblique angle relative to the surface of the component. The method further may include passing the ultrasonic signal through a transducer fixture configured to at least partially collimate the ultrasonic signal. The method also may include receiving via the transducer a return signal reflected from the surface of the component, and determining, based at least in part on the return signal, whether a crack exists in the surface of the component.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1A is a schematic perspective view of an example crack detection assembly for automated non-destructive inspection of a component, including a perspective view of an example component for inspection, according to embodiments of the disclosure.

FIG. 1B is an enlarged view of the example component for inspection shown in FIG. 1A, according to embodiments of the disclosure.

FIG. 1C is a schematic front view of the example crack detection assembly shown in FIG. 1A, including the perspective view of the example component for inspection shown in FIG. 1A, according to embodiments of the disclosure.

FIG. 1D is a schematic side view of the example crack detection assembly shown in FIG. 1A, including the perspective view of the example component for inspection shown in FIG. 1A, according to embodiments of the disclosure.

FIG. 1E is a schematic close-up view of an example transducer fixture and example transducer of the example crack detection assembly shown in FIG. 1A, including a close-up view of the example component for inspection shown in FIG. 1A, according to embodiments of the disclosure.

FIG. 2A is a schematic side view of an example transducer fixture and an example transducer, according to embodiments of the disclosure.

FIG. 2B is a schematic top view of the example transducer fixture and example transducer shown in FIG. 2A, according to embodiments of the disclosure.

FIG. 2C is a schematic front view of the example transducer fixture and example transducer shown in FIG. 2A, according to embodiments of the disclosure.

FIG. 3 is a schematic diagram of the transducer fixture and transducer shown in FIGS. 2A and 2B emitting an example ultrasonic signal through an example fixture front face, illustrating an example of the fixture front face at least partially collimating the ultrasonic signal, according to embodiments of the disclosure.

FIG. 4A is a schematic side view diagrammatically illustrating an example transducer fixture and example transducer travelling along an example contoured surface of an example component, with the transducer emitting an example ultrasonic signal toward an example target inspection area, according to embodiments of the disclosure.

FIG. 4B is a schematic view of an example display device depicting an example representation of an example return signal received by the transducer of FIG. 4A for an example component lacking a surface irregularity or flaw, such as a crack, according to embodiments of the disclosure.

FIG. 4C is a schematic side view similar to the view of FIG. 4A diagrammatically illustrating an example transducer fixture and example transducer travelling along another example contoured surface of another example component, with the transducer emitting an example ultrasonic signal toward an example target inspection area, according to embodiments of the disclosure.

FIG. 4D is a schematic view of an example display device depicting an example representation of an example return signal received by the transducer of FIG. 4C for an example component having a surface irregularity or flaw, such as a crack, according to embodiments of the disclosure.

FIG. 5A is a schematic view of an example first side of an example ultrasonic transducer, according to embodiments of the disclosure.

FIG. 5B is a schematic view of an example second side of the example ultrasonic transducer shown in FIG. 5A, according to embodiments of the disclosure.

FIG. 5C is a schematic view of an example edge of the example ultrasonic transducer shown in FIG. 5A, according to embodiments of the disclosure.

FIG. 5D is a schematic view of the example second side of the example ultrasonic transducer shown in FIG. 5B, including an example first electrical conductor and an example second electrical conductor connected to respective electrical contact points of the ultrasonic transducer, according to embodiments of the disclosure.

FIG. 6A is a schematic side view of an example crack detection assembly, including an example transducer fixture and example transducer, separated from an example surface of an example component for inspection prior to beginning inspection of the component, according to embodiments of the disclosure.

FIG. 6B is a schematic side view of the example crack detection assembly shown in FIG. 6A after the example transducer fixture and transducer have approached and contacted the surface of the component for inspection once the inspection of the component has commenced, according to embodiments of the disclosure.

FIG. 7A is a schematic side view of an example couplant valve in an example closed condition, according to embodiments of the disclosure.

FIG. 7B is a schematic side view of the example couplant valve shown in FIG. 7A in an example open condition, according to embodiments of the disclosure.

FIG. 8A is a schematic perspective view of an example crack detection assembly, including an example transducer fixture and example transducer, separated from an example surface of an example component for inspection prior to beginning inspection of the component, according to embodiments of the disclosure.

FIG. 8B is a schematic view of an example display device depicting an example representation of an example return signal received by the transducer of FIG. 8A for an example component for inspection, prior to beginning inspection of the component, according to embodiments of the disclosure.

FIG. 8C is a schematic perspective view of the example crack detection assembly shown in FIG. 8A after the example transducer fixture and transducer have approached and contacted the surface of the component for inspection, once the inspection of the component has commenced, according to embodiments of the disclosure.

FIG. 8D is a schematic view of an example display device depicting an example representation of an example return signal received by the transducer of FIG. 8C for an example component having a surface irregularity or flaw, such as a crack, according to embodiments of the disclosure.

FIG. 9A is a schematic perspective view diagrammatically illustrating an example transducer fixture and example transducer travelling along another example contoured surface of another example component, with the transducer emitting an example ultrasonic signal toward an example target inspection area, according to embodiments of the disclosure.

FIG. 9B is a schematic view of an example display device depicting an example representation of an example return signal received by the transducer of FIG. 9A for an example component having a surface irregularity or flaw, such as a crack, according to embodiments of the disclosure.

FIG. 10 is a graph showing an example correlation between relative return signal level and crack size, according to embodiments of the disclosure.

FIG. 11 is a block diagram of an example electrical assembly for an example crack detection assembly, including a control circuit for providing power and control to an example transducer, according to embodiments of the disclosure.

FIG. 12 is an example block diagram of an example process for operating an example crack detection assembly, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

The present disclosure generally is directed to assemblies, apparatuses, and methods providing enhanced non-destructive inspection of components that produce relatively more accurate results, relatively more consistent results, and/or relatively more reliable results. For example, in some embodiments, an ultrasonic signal may be emitted toward the surface of a component being inspected, and a return signal reflected from the surface of the component may be used to determine whether a crack exists in the surface of the component. In some embodiments, the assemblies, apparatuses, and methods presented herein may provide more accurate, more consistent, and/or more reliable results, for example, during inspection of components having irregular or inconsistent physical three-dimensional surface geometries. In some embodiments, the assemblies, apparatuses, and methods presented herein may be used in combination with robotic mechanisms, such as, for example, robotic arms, including, in some embodiments, robotic arms preprogrammed to move an ultrasonic transducer according to an inspection strategy designed to inspect a predetermined area of a component being inspected. Although some examples described herein are explained in relation to inspection of aircraft components for the purpose of explanation, inspection of other types of components for other types of machines is contemplated. In addition, although some examples of the assemblies, apparatuses, and methods for inspection described herein are explained in relation to use with programmed (e.g., preprogrammed) robotic mechanisms for the purpose of explanation, use without such mechanisms (e.g., manual use by one or more human technicians), and/or with other types of mechanisms is contemplated. Additionally, although some examples of the assemblies, apparatuses, and methods for inspection described herein are explained in relation to use for crack detection, use for detection of other types of component irregularities and/or flaws (e.g., other types of surface irregularities and/or surface flaws) is contemplated. It is also contemplated that artificial intelligent, for example, including machine-learning trained programs and/or algorithms, may be leveraged to interpret signals generated and/or signals reflected during component inspection.

In some embodiments, an ultrasonic signal, such as ultrasonic surface waves, may be emitted via a transducer to a point on a surface of a component being inspected at a position spaced from a target inspection area. For a target inspection area of component that does not have an irregularity or flaw, such as a crack, the emitted surface waves continue to propagate along the surface of the component over the target inspection area without a return signal indicative of an irregularity or flaw. If an irregularity or flaw, such as a crack, is present in the target inspection area, however, the emitted surface waves interact with the irregularity or flaw and are reflected from the irregularity or flaw face and propagate back toward a receiver of the transducer. In some embodiments, during use of such a “pulse-echo” detection technique, the return signal, including reflected waves, may be detected by the transducer. In some embodiments, the level or amplitude of the return signal may be measured, and the measured level or amplitude may be indicative of the magnitude of the irregularity, such as, for example, the width and/or depth of a crack. Although some examples of the assemblies, apparatuses, and methods for inspection described herein are explained in relation to use of a transducer for the purpose of explanation, the use of equivalents, such as, for example, separate signal generators and separate signal receivers are contemplated, as well as other equivalent types of devices for emitting signals and receiving reflected signals.

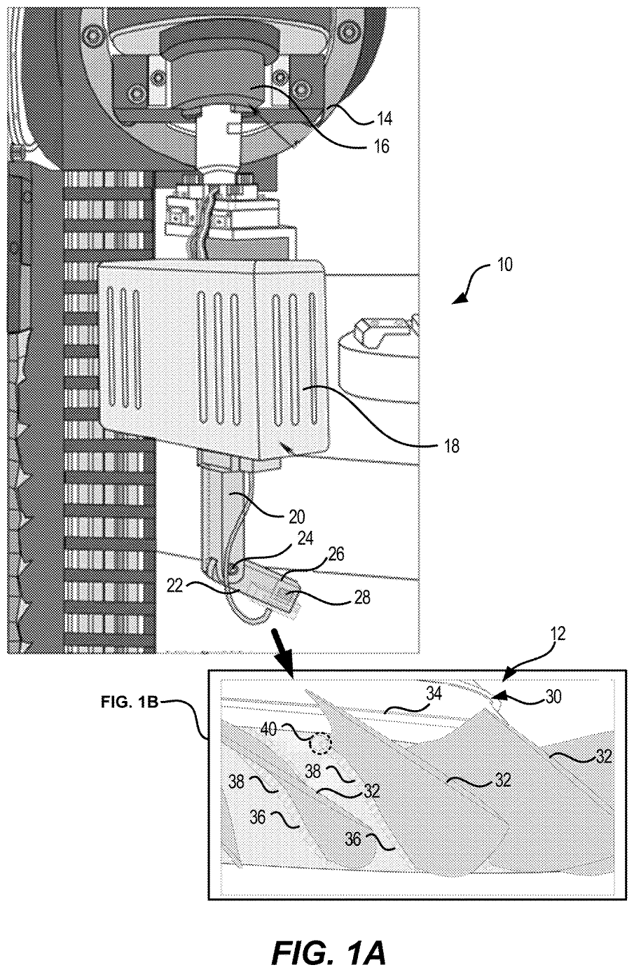

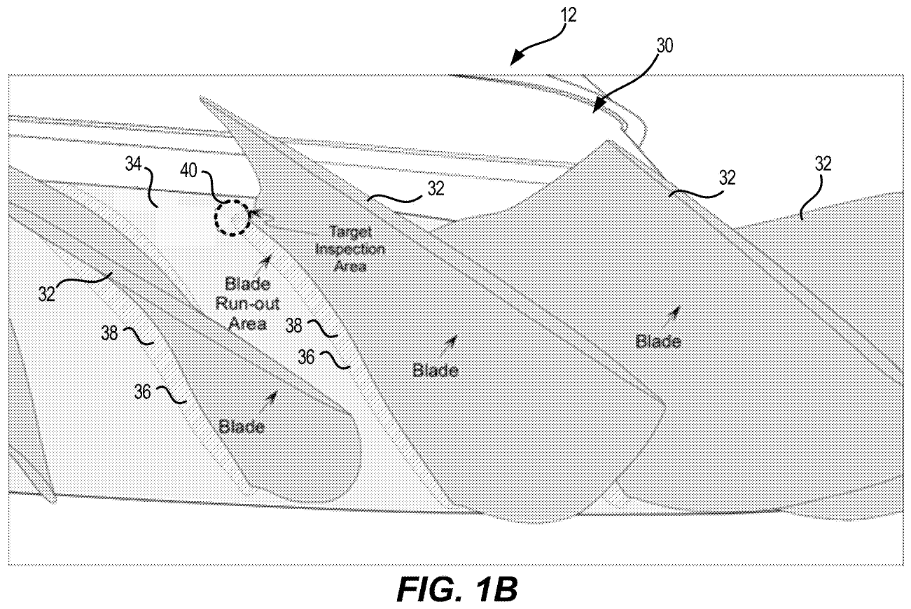

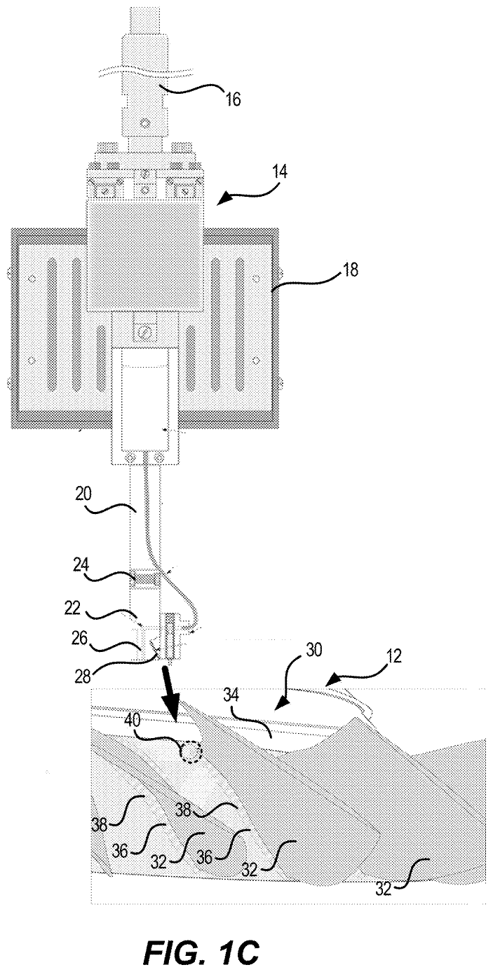

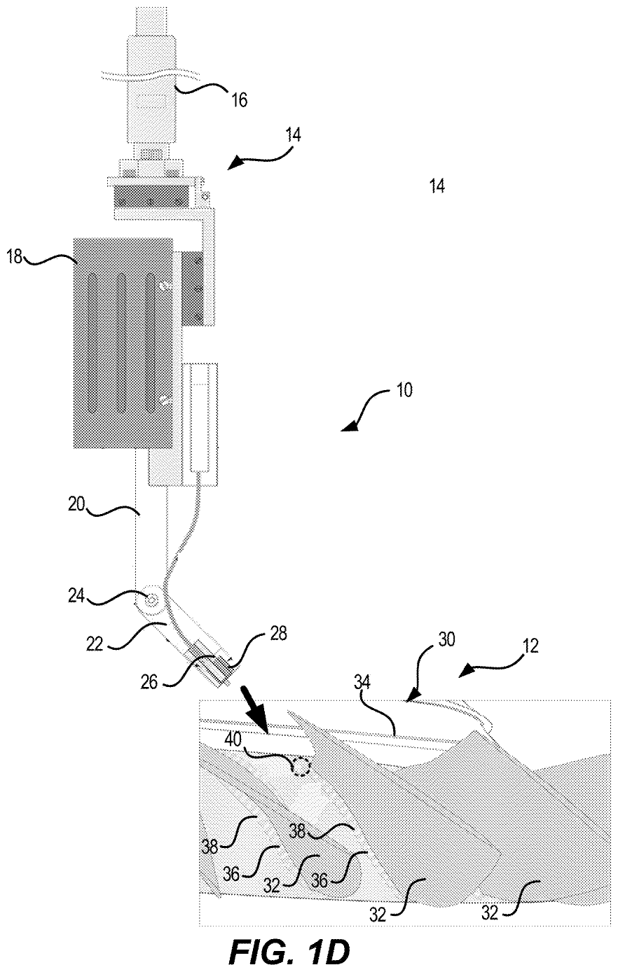

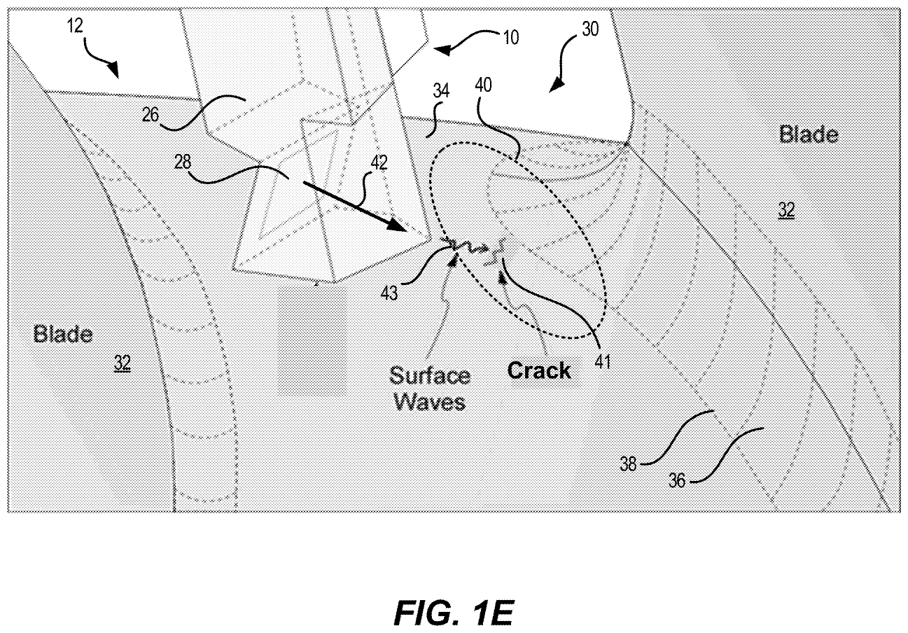

FIG. 1A is a schematic perspective view of an example crack detection assembly 10 for automated non-destructive inspection of a component 12, including a perspective view of an example component 12 for inspection, according to embodiments of the disclosure. In some embodiments, as shown in FIG. 1A, the crack detection assembly 10 may include a robotic mechanism 14 including a probe holding chuck 16 configured to be coupled to an electrical housing 18 and an upper arm 20 and a lower arm 22 pivotally coupled to one another via a pivot joint 24. As shown, in some embodiments, the lower arm 22 may be coupled to a transducer fixture 26, which may carry an ultrasonic transducer 28. The probe holding chuck 16, the upper arm 20, the lower arm 22, and/or the pivot joint 24 may be controlled, for example, via one or more electronic control circuits and/or electric power circuits, for example, housed in the electrical housing 18, and/or via one or more actuators. For example, the probe holding chuck 16, the upper arm 20, the lower arm 22, the pivot joint 24, one or more electronic control circuits, the one or more electric power circuits, and/or the one or more actuators may form part of the robotic mechanism 14, such as a preprogrammed robotic mechanism, which may be used to semi-or fully-autonomously control movement of at least some of the remainder of the crack detection assembly 10 relative to the component 12.

FIG. 1B is an enlarged view of the example component 12 for inspection shown in FIG. 1A, according to embodiments of the disclosure. The example component shown in FIG. 1B is a turbine engine rotor 30, including a plurality of blades 32 coupled to an outer diameter of a hub 34 of the rotor 30 along respective elongated joints 36 between the hub 34 and each of the blades 32. Each of the joints 36 may include a tapered or smoothed transition 38 sometimes referred to as a “blade run-out area.” For a turbine engine rotor 30, a common area of crack propagation resulting from fatigue over time with use is located at an end of a respective blade 32 at the transition 38 with the hub 34. As a result, this is often a target inspection area 40 when inspecting a rotor 30 for irregularities and flaws, such as cracks. Although components such as rotors and blades are described herein for the purpose of explanation, other types of components and/or other types of machines and associated components are contemplated.

FIG. 1C is a schematic front view of the example crack detection assembly 10 shown in FIG. 1A, including the perspective view of the example component 12 for inspection shown in FIG. 1A, according to embodiments of the disclosure, and FIG. 1D is a schematic side view of the example crack detection assembly 10 shown in FIG. 1A, including the perspective view of the example component 12 for inspection shown in FIG. 1A, according to embodiments of the disclosure. FIG. 1E is a schematic close-up view of the example transducer fixture 26 and the example transducer 28 of the example crack detection assembly 10 shown in FIG. 1A, including a close-up view of the example component 12, including an example irregularity and/or flaw, such as a crack 41, according to embodiments of the disclosure. As shown in FIGS. 1C-1E, in some embodiments, the robotic mechanism 14 may be used to move and/or orient the transducer fixture 26 relative to the surface of the component 12 for inspecting the component 12, for example, as described herein. As schematically depicted in FIG. 1E, in some embodiments, the transducer 28 may be configured to emit an ultrasonic signal 42 toward and/or into the surface of component 12, for example, in a direction generally toward a target inspection area 40 of the component 12 in order to detect component irregularities and/or flaws, such as the example crack 41. The ultrasonic signal 42 may result in a mode-converted surface wave signal 43 traveling in the general direction toward the target inspection area 40, for example, as schematically depicted in FIG. 1E.

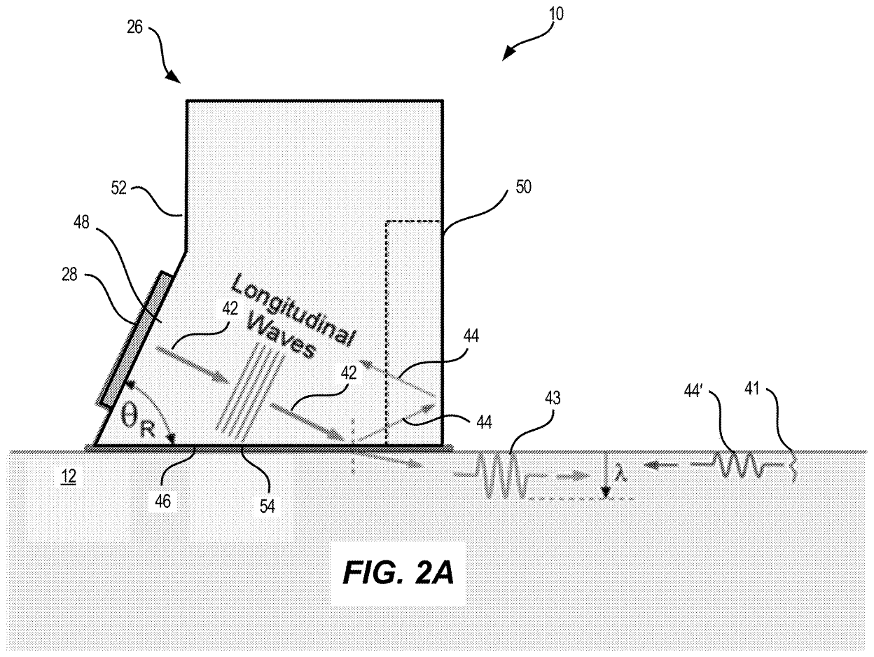

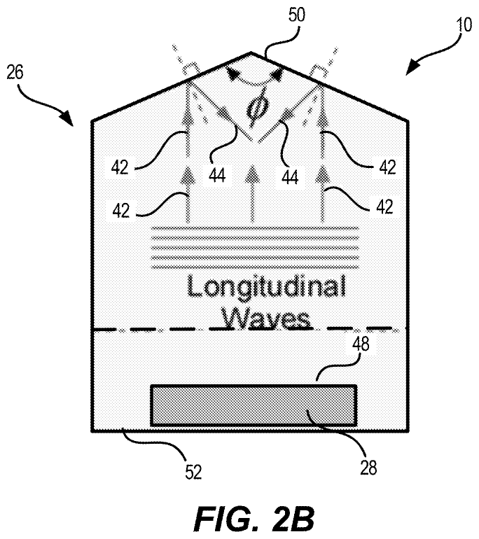

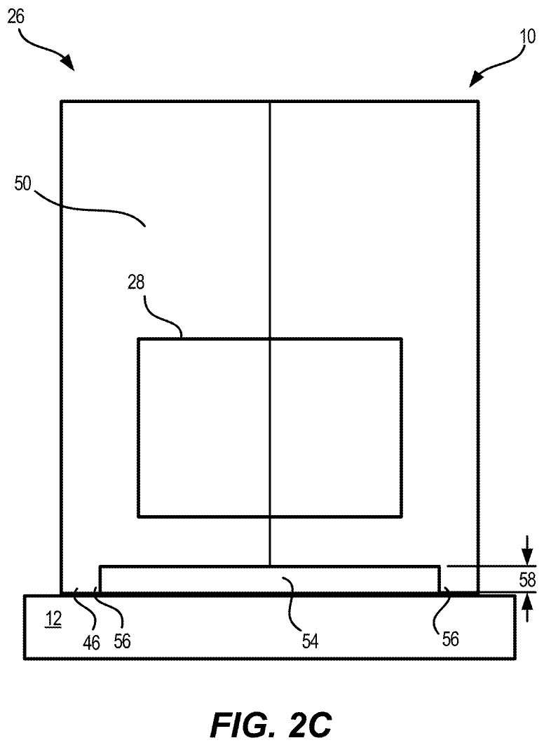

FIG. 2A is a schematic side view of an example transducer fixture 26 and an example transducer 28, according to embodiments of the disclosure. FIG. 2B is a schematic top view of the example transducer fixture 26 and example transducer 28 shown in FIG. 2A, and FIG. 2C is a schematic front view of the example transducer fixture 26 and example transducer 28 shown in FIG. 2A, according to embodiments of the disclosure.

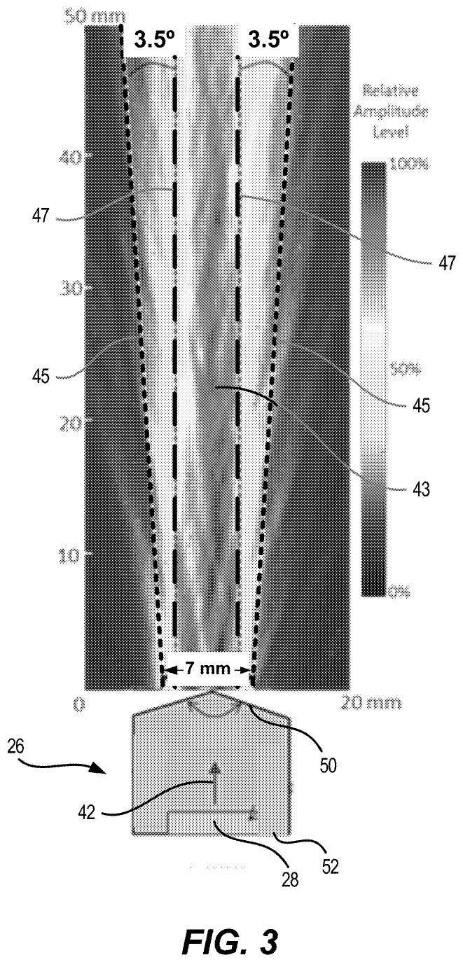

As shown in FIGS. 2A-2C, in some embodiments, the crack detection assembly 10 may include an ultrasonic transducer 28 configured to emit the ultrasonic signal 42 into a surface of the component 12. The ultrasonic signal 42 may result in a mode-converted surface wave signal 43, for example, as schematically depicted in FIG. 2A. When the surface wave signal 43 reaches an irregularity and/or flaw, such as the example crack 41, a return signal 44′ may be reflected from the irregularity and/or flaw, and the ultrasonic transducer 28 may be configured to receive the return signal 44′, thereby detecting the irregularity and/or flaw in the component 12 (e.g., in the surface of the component 12). As shown, the crack detection assembly 10 further may include a transducer fixture 26 coupled to the ultrasonic transducer 28. The transducer fixture 26 may be substantially transparent to the ultrasonic signal 42 and/or the signal 44′. For example, the transducer fixture 26 may include or be formed of one or more materials, such as, for example, acrylic, although similar materials other than acrylic are contemplated. The transducer fixture 26 may include a fixture base 46, and the fixture base 46 may be substantially planar and configured to approach (e.g., at least partially contact) the surface of the component 12 when emitting the ultrasonic signal 42 and receiving the return signal 44′. The transducer fixture 26 further may include a fixture transducer mount 48, and the ultrasonic transducer 28 may be coupled (e.g., directly coupled) to the fixture transducer mount 48, such that the ultrasonic signal 42 is emitted at a mount angle θ_{R} relative to the fixture base 46, for example, as shown in FIG. 2A. In some embodiments, the mount angle θ_{R} may be oblique relative to the fixture base 46. The transducer fixture 26 also may include a fixture front face 50 extending away from the fixture base 46. In some embodiments, the fixture front face 50 may have a cross-section substantially parallel to the fixture base 46, and the cross-section may be at least partially V-shaped, thereby to at least partially collimate the ultrasonic signal 43, for example, as described herein with respect to FIG. 3.

In some embodiments, the mount angle θ_{R} may range from about 45 degrees to about 80 degrees. For example, in some embodiments, the mount angle θ_{R} may range from about 50 degrees to about 75 degrees, for example, from about 55 degrees to about 70 degrees, such as, for example, from about 60 degrees to about 70, for example, about 65 degrees.

In some embodiments, the transducer fixture 26 may be configured to propagate an ultrasonic surface wave 43 (e.g., via ultrasonic signal(s) 42) along the surface of the component 12 at an angle. For example, as shown in FIGS. 2A and 2B, in some embodiments, surface waves 43 may be generated by, for example, a longitudinal mode piezoelectric element mounted on the fixture transducer mount 48, which may present a slanted side of the transducer fixture 26 at the mount angle θ_{R}, which may substantially correspond to the Rayleigh angle. For example, in some embodiments, this angle may be defined by, for example, θ_{R}=sin⁻¹(Vₗ¹/V_{R}²), where Vₗ¹ and V_{R}² are the respective longitudinal wave velocities in the material forming the transducer fixture 26 and the Rayleigh wave velocity in the material forming the component 12. Without wishing to be bound by theory, Applicant believes that upon interaction of longitudinal waves 42 with the surface of the component 12 at the mount angle θ_{R}, a portion of ultrasonic energy is transmitted into the component 12, and substantially the remainder of the energy is reflected from the surface of the component and continues its propagation toward the fixture front face 50, as indicated by the arrows 44 in FIGS. 2A and 2B. The longitudinal waves transmitted to the component 12 may be converted into the surface waves 43 through mode conversion. These surface-bound waves 43 may propagate unidirectionally within the depth of one wavelength λ of the operating frequency. For example, at 5 MHz, the wavelength λ is approximately 0.6 millimeters (or roughly 0.024 inches) for titanium and Inconel superalloys. FIG. 2B, a top view of FIG. 2A, illustrates example reflections of remnant longitudinal waves 44 for an example shape of fixture front face 50. In the example shown, without wishing to be bound by theory, it is believed by Applicant that the fixture front face 50 having a V-shaped cross-section as shown in FIG. 2B redirects the reflected remnant longitudinal wave signals 44 (e.g., reflected waves) laterally away from the return signals 44′ to minimize the detection of remnant longitudinal wave signals 44 by the transducer 28, for example, by reducing overlap of the reflected remnant longitudinal wave signals 44 with the return signals 44′ reflected by the irregularity and/or flaw, such as the crack 41. This may serve to improve the accuracy, the consistency, and/or the reliability of the detection of the return signals 44′ reflected by the irregularity and/or flaw in the component 12.

In some embodiments, the V-shaped cross-section of the fixture front face 50 may at least partially define a V angle φ ranging from about 100 degrees to about 160 degrees. For example, in some embodiments, the V angle φ may range from about 110 degrees to about 150 degrees, for example, from about 120 degrees to about 140 degrees, such as, for example, from about 125 degrees to about 135, for example, from about 130 degrees to about 135 degrees.

As shown in FIGS. 2A-2C, in some embodiments, the fixture front face 50 is opposite the fixture transducer mount 48 and extends away from the fixture base 48 at a front face angle relative to the fixture base 46 ranging from about 70 degrees to about 110 degrees. For example, the front face angle may range from about 80 degrees to about 100 degrees, or from about 85 degrees to about 95 degrees, for example, about 90 degrees.

As shown in FIG. 2A, in some embodiments, the fixture transducer mount 48 may be associated with a fixture rear 52 substantially opposite the fixture front face 50. As shown, at least a portion of fixture rear 52 (e.g., the fixture transducer mount 48) may extend obliquely away from the fixture base 46, for example, substantially at the mount angle θ_{R}.

As shown in FIG. 2C, in some embodiments, the transducer fixture 26 further may include a couplant recess 54 in the fixture base 46. For example, the couplant recess 54 may have a recess perimeter 56 and a recess depth 58. The couplant recess 54 may be configured to receive couplant therein, for example, as described herein. In some embodiments, the recess depth 58 may at least partially define a couplant thickness, for example, when the fixture base 46 is in contact with the surface of the component 12. Couplant may substantially fill the couplant recess 54, such that the couplant in the couplant recess 54 has a thickness substantially equal to the recess depth 58 of the couplant recess 54.

It has been surprisingly discovered by Applicant that an amount of couplant volume between the fixture base 46 of the transducer fixture 26 and the surface of the component 12 may affect the conversion efficiency of longitudinal waves to surface waves 43 when interacting with the component 12. For example, a relatively lower mode conversion efficiency occurred when the transducer fixture 26 made direct contact with the component 12 with a thin couplant layer. Improved mode conversion efficiency, relatively speaking, was observed when a small spacing filled with couplant was formed between the fixture base 46 and the component 12. In some embodiments, relatively improved conversion efficiency was observed when the gap between the fixture base 46 and the surface of the component 12 was approximately 0.06 mm (or roughly 0.0024 inches), for example, with isopropanol used as the couplant. In one example, using a wavelength (λ) calculation formula, λ=velocity/frequency, the wavelength of the 5 MHz signal is 0.241 mm with the longitudinal mode sound velocity of 1,205 meters per second (m/s) in isopropanol. Without wishing to be bound by theory, this example 0.06 mm gap is almost equal to the quarter wavelength of 5 MHz longitudinal waves in isopropanol and acts like an impedance-matching layer to convert the longitudinal waves to surface waves 43 with an improved efficiency. This example gap may vary depending on, for example, the ultrasonic properties of the couplant used for the inspection. For example, with water as the couplant, the quarter wavelength spacing may be about 0.075 mm (or roughly 0.003 inches) with a sound velocity of 1,493 m/s in water. Applicant believes a potential advantage of using isopropanol as a couplant instead of water or gel may be the lower surface tension property. Alcohol does not form beads on the surface, so it spreads thin instead of sticking together. The spreading property may provide a relatively faster evaporation rate from the surface of the component 12 being inspected. As a result, it may be relatively easier to control the proper amount of couplant retained on the surface of the component 12 being inspected.

In some embodiments, to help establish a consistent gap filled with the couplant between the fixture base 46 and the surface of the component 12 during an inspection, a couplant recess 54 may be provided in the fixture base 46. In some embodiments, for example, for an isopropanol couplant, the recess depth 58 may be approximately 0.06 mm, for example, as measured from the lowest part of the fixture base 46. The width of the couplant recess may be slightly wider than the width of the transducer 28, for example, to prevent edge reflections from sharp inner side edges of the couplant recess 54. As an example, comparison of the effect of the couplant recess 54 with a flat bottom fixture base, amplitudes of EDM notch reflected surface wave signals were measured. The width of the notch-oriented perpendicular to the wave propagation was 2.5 mm (or roughly about 0.1 inch) long and 1.25 mm (or roughly about 0.05 inches) deep, with a half-circle shape on a 12 mm (or roughly about 0.5 inches) thick titanium plate. The stand-off distance between the notch and the fixture front face 50 was about 12 mm (or roughly about 0.5 inches). The peak-to-peak amplitude of the notch signal as depicted in an oscilloscope was about 140 millivolts (mV). In contrast, with a flat bottom fixture base 46 (e.g., without a couplant recess), the corresponding peak-to-peak amplitude was measured to be 55 mV. The difference between the two measured amplitudes is about 85 mV, which is more than an 8 dB increase in the amplitude with the 0.06 mm deep couplant recess 54. At least in some embodiments, a stronger reflected signal substantially corresponds to an improved signal-to-noise ratio, which may result in a relatively reduced uncertainty in measurement.

FIG. 3 is a schematic diagram of the transducer fixture 26 and transducer 28 shown in FIGS. 2A and 2B emitting an example ultrasonic surface wave signal 43 through an example fixture front face 50, illustrating an example of the fixture front face 50 at least partially collimating the ultrasonic surface wave signal 43, for example, as described herein with respect to FIGS. 2A and 2B, according to embodiments of the disclosure. For example, FIG. 3 illustrates a visualized surface wavefield 43 over an example propagation distance of 50 mm (or roughly 2 inches). The example wavefield was generated by using an example embodiment of the transducer fixture 26 formed from acrylic having an example V angle φ of about 134 degrees. In the example depicted, transducer 28 is a 5 MHz square-shaped piezoelectric element having example dimensions of 7 mm by 7 mm (or roughly 0.28 inches by 0.28 inches), and was mounted at an example mount angle θ_{R} of about 64 degrees. For the purpose of testing a 12 mm (or roughly 0.5 inches) thick titanium plate was used as the test component 12. From the wavefield image shown in FIG. 3, it is noticeable that there is an about 3.5 degrees beam spread angle on each side of the main lobe, indicated by the dotted lines 45, while there is almost no beam spread in the main lobe indicated by the dotted lines 47. Based on the relative amplitude level chart on the right-hand side of the image, there is about a 20% decrease in the amplitude of the main lobe due to material attenuation over a distance of about 50 mm. It should be noted that the 5 MHz piezoelectric element as the example transducer 28 used in this test was fabricated from a Lead Zirconate Titanate (PZT) piezoelectric ceramic material.

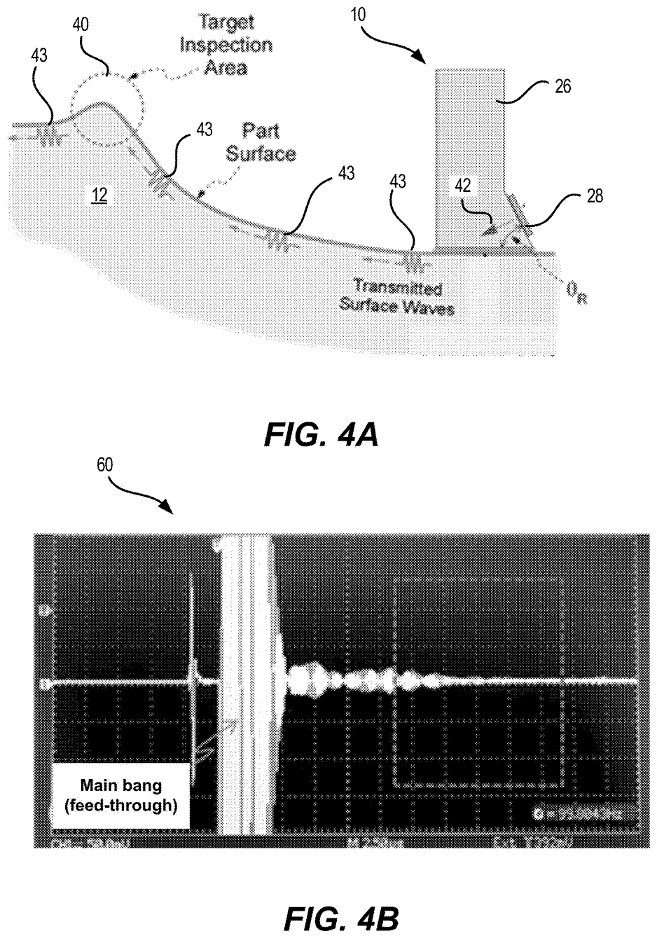

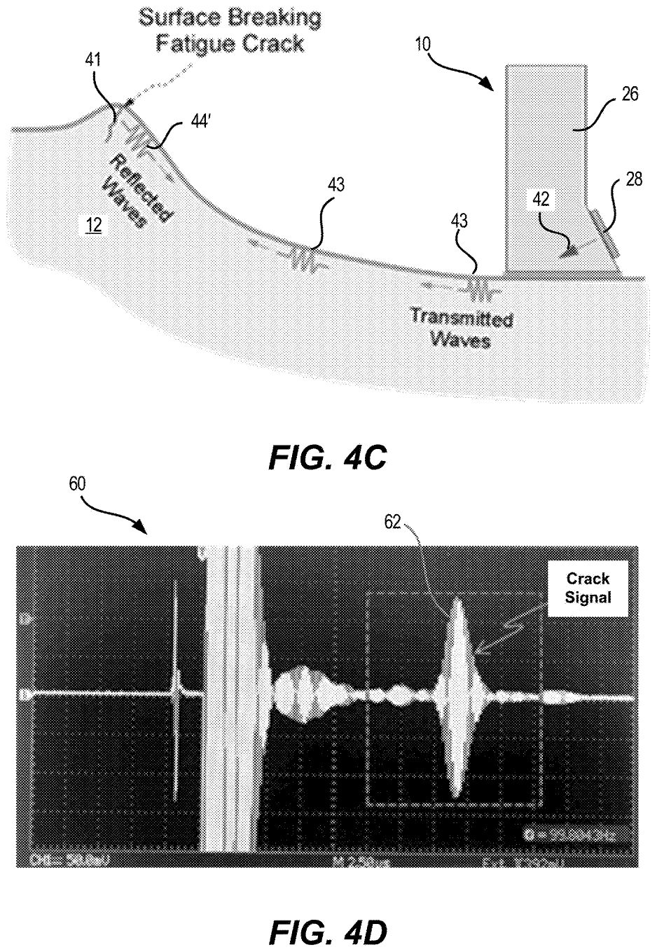

FIG. 4A is a schematic side view diagrammatically illustrating an example transducer fixture 26 and example transducer 28 travelling along an example contoured surface of an example component 12, with the transducer 28 emitting an example ultrasonic signal 42 toward an example target inspection area 40, according to embodiments of the disclosure. FIG. 4B is a schematic view of an example display device 60 depicting an example representation 62 of an example return signal 44′ received by the transducer 28 of FIG. 4A for an example component 12 lacking a surface irregularity or flaw, such as a crack, according to embodiments of the disclosure. For example, the display device 60 may be in signal communication with the ultrasonic transducer 28, and the display device 60 may be configured to depict the representation 62 of the return signal 44′. The display device 60 may be or include any known type of device capable of displaying such a representation 62, such as, for example, a mobile device display, a tablet display, a computer display, and/or an oscilloscope. Other types of display devices 60 are contemplated. FIG. 4C is a schematic side view similar to the view of FIG. 4A diagrammatically illustrating an example transducer fixture 26 and example transducer 28 travelling along another example contoured surface of another example component 12, with the transducer 28 emitting an example ultrasonic signal 42 toward an example target inspection area 40, according to embodiments of the disclosure. FIG. 4D is a schematic view of an example display device 60 depicting an example representation 62 of an example return signal 44′ received by the transducer 28 of FIG. 4C for an example component 12 having a surface irregularity or flaw, such as a crack 41, according to embodiments of the disclosure.

As shown in FIGS. 4A-4D, in some embodiments, ultrasonic surface waves 43 (e.g., from emitted ultrasonic signals 42) may be emitted from a distance from the target inspection area 40, for example, as schematically illustrated in FIG. 4A. The emitted surface waves 43 continue to propagate along the surface over the target inspection area 40 under normal conditions with no indication of a crack signal, for example, as depicted in FIG. 4B on the example display device 60. In some embodiments, if an irregularity, flaw, or crack is present in the target inspection area 40, for example, as schematically shown in FIG. 4C, the transmitted surface waves 43 may interact with the crack 41 and be reflected from the crack face and propagate back toward the transducer 28. In some embodiments, by using this example detection technique, the reflected surface waves (e.g., reflected signals 44′) may be detected by the transducer 28 (and/or another sensor). The amplitude of reflected surface waves may be measured, for example, as depicted in the example display device 60 shown in FIG. 4D.

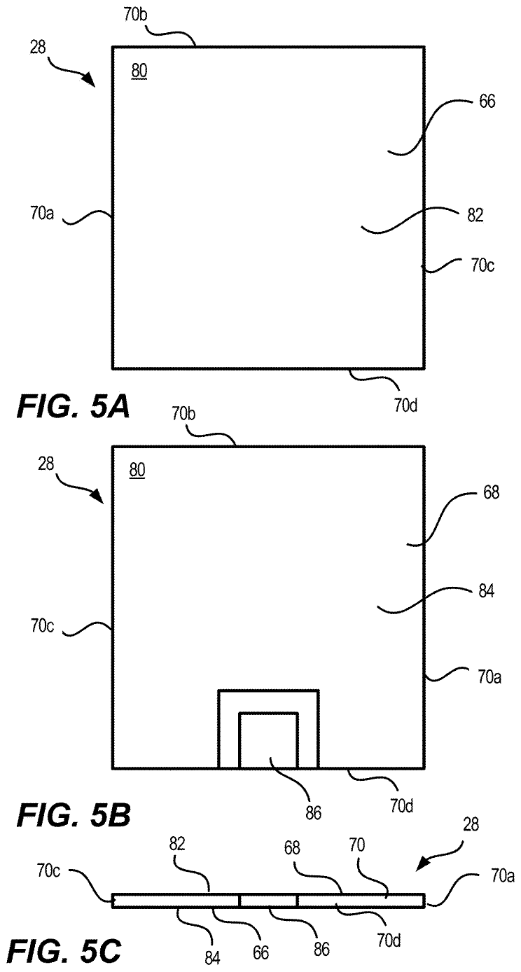

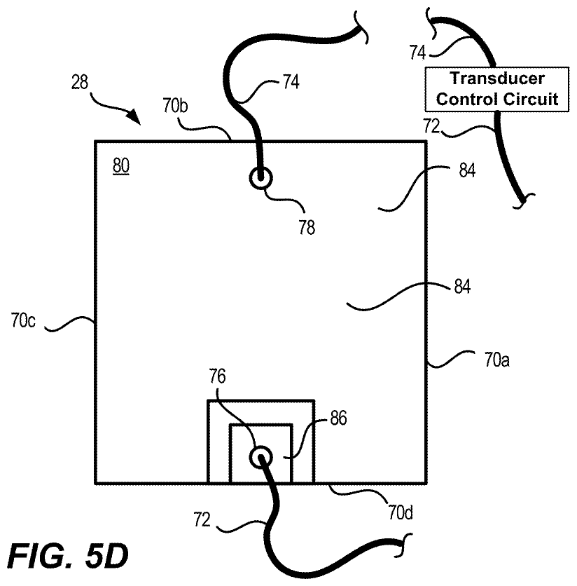

FIG. 5A is a schematic view of an example first side 66 of an example ultrasonic transducer 28, according to embodiments of the disclosure. FIG. 5B is a schematic view of an example second side 68 of the example ultrasonic transducer 28 shown in FIG. 5A, according to embodiments of the disclosure. FIG. 5C is a schematic view of an example edge 70 of the example ultrasonic transducer 28 shown in FIG. 5A, according to embodiments of the disclosure. FIG. 5D is a schematic view of the example second side 68 of the example ultrasonic transducer 28 shown in FIG. 5B, including an example first electrical conductor 72 and an example second electrical conductor 74 connected to respective first and second electrical contact points 76 and 78 of the ultrasonic transducer 28, according to embodiments of the disclosure.

In some embodiments, the ultrasonic transducer 28 may include a piezoelectric element, and the piezoelectric element may be or include a wafer 80 at least partially defined by: the first side 66, the second side 68 opposite the first side 66, and four edges 70a, 70b, 70c, and 70d, at a perimeter of the wafer 80. The first side 66 may have a first conducting coating 82 (e.g., electrically conducting, such as gold foil or another type of similar conductor) and the second side 68 may have a second conducting coating 84 (e.g., electrically conducting, such as gold foil or another type of similar conductor). In some embodiments, three of the four edges 70a-70d may be substantially devoid of conducting coating, and a fourth edge (e.g., 70d) of the four edges 70a-70d may have a conducting coating tab 86 extending from the first side 66, traversing the fourth edge 70d, and onto the second side 68, and the conducting coating tab 86 may be spaced from the second conducting coating 84, for example, as shown in FIGS. 5B and 5D.

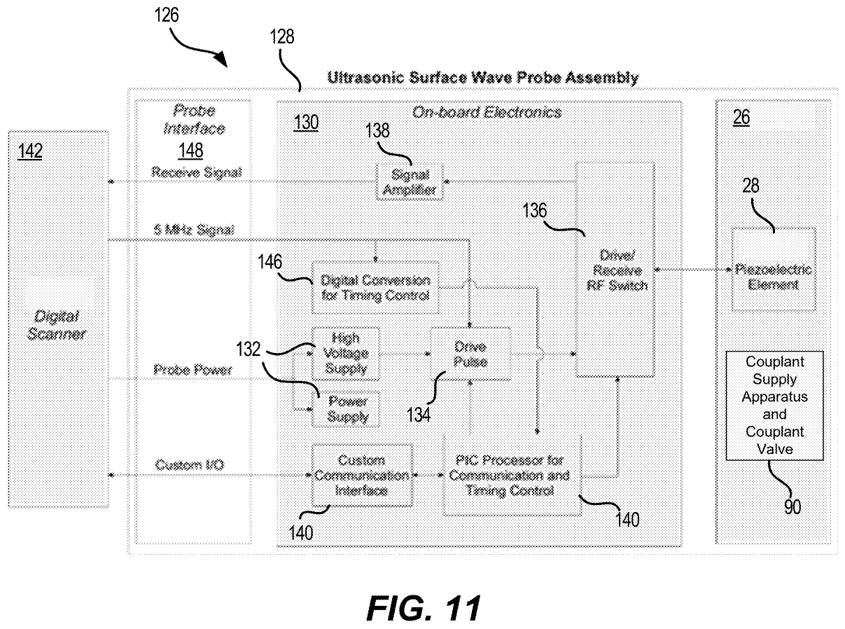

As shown in FIG. 5D, for example, the first electrical conductor 72 may be attached to the conducting coating tab 86 at the first electrical contact point 76, and a second electrical conductor 74 may be attached to the second conducting coating 84 at the second electrical contact point 78, for example, along an edge (e.g., edge 70d) of the second side 68 opposite the conducting coating tab 86. In some embodiments, the first and second electrical conductors 72 and 74 may be electrically connected to a transducer control circuit 88, for example, as described herein with respect to FIG. 11. In some embodiments, the ultrasonic transducer 28 may be coupled to the fixture transducer mount 48 with the first side 66 facing into the transducer fixture 26 and generally toward the fixture front face 50 and the fixture base 46 substantially at the mount angle θ_{R}, for example, with the first and second electrical conductors 72 and 74 facing away from the fixture transducer mount 48. Although the example transducer 28 shown in FIGS. 5A-5D is rectangular, other shapes and configurations for the transducer 28 are contemplated.

In at least some embodiments consistent with FIGS. 5A-5D, a 5 MHz piezoelectric element may be used for the transducer 28, which may be manufactured from, for example, a lead zirconate titanate (PZT) piezoelectric ceramic material. As shown in FIGS. 5A-5D, the transducer 28 may include a keyhole electrode that wraps around one edge of the wafer 80, for example, as shown in FIGS. 5B-5D, which facilitates connecting (e.g., soldering) both the first and second electrical conductors 72 and 74 (e.g., electrical wires) from the second side 68 of the wafer 80, which may be a top surface, which prevents the need to connect one of the electrical conductors 72 or 74 on a bottom surface of the wafer 80, which may be challenging for manufacturing the transducer fixture 26, for example, providing a recessed hole on the fixture transducer mount 48's angled surface and soldering an electrical conductor at the correct location on the wafer 80's surface, so that it can be properly aligned with the recessed hole on the transducer fixture 26. If misaligned with the fixture front face 50, an asymmetrical wavefield may be produced, having a skewed beam launch direction, which may, in turn, result in inaccurate, inconsistent, and/or unreliable results for inspection purposes.

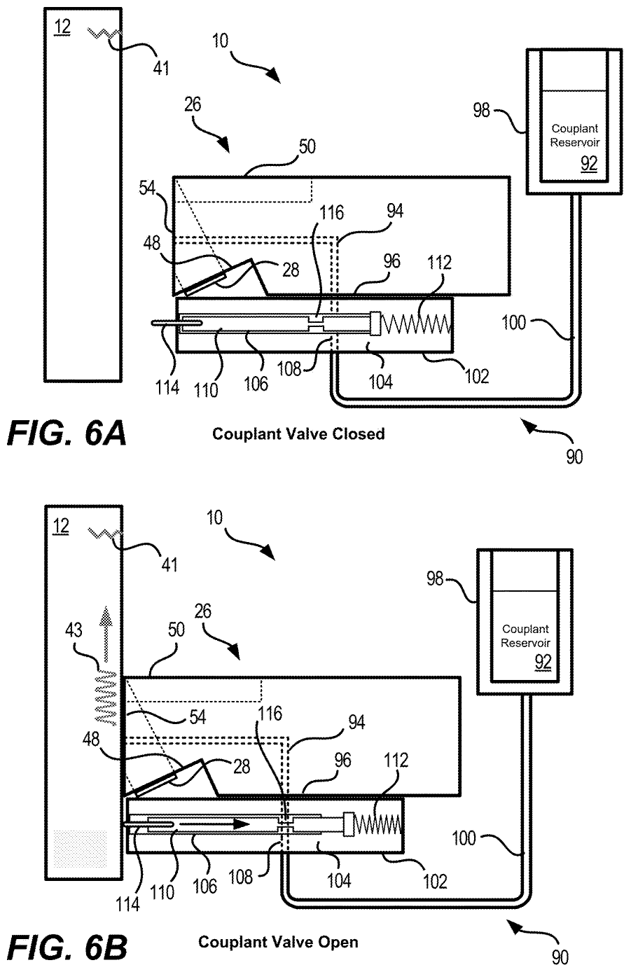

FIG. 6A is a schematic side view of an example crack detection assembly 10, including an example transducer fixture 26 and example transducer 28, separated from an example surface of an example component 12 for inspection prior to beginning inspection of the component 12, according to embodiments of the disclosure. FIG. 6B is a schematic side view of the example crack detection assembly 10 shown in FIG. 6A after the example transducer fixture 26 and transducer 28 have approached and contacted (e.g., via the couplant and/or directly) the surface of the component 12 for inspection once the inspection of the component 12 has commenced, according to embodiments of the disclosure.

As shown in FIGS. 6A and 6B, in some embodiments, the transducer fixture 26 may include a couplant recess 54 in the fixture base 46, for example, as described herein, and the crack detection assembly 10 further may include a couplant supply apparatus 90 coupled to the transducer fixture 26 to supply couplant 92 to the couplant recess 54. The transducer fixture 26 may at least partially define therein a couplant passage 94 between a surface 96 of the transducer fixture 26 and the couplant recess 54, and the couplant passage 94 may provide fluid flow between the couplant supply apparatus 90 and the couplant recess 54. As shown in FIGS. 6A and 6B, the couplant supply apparatus 90 may include a couplant reservoir 98 configured to contain a supply of the couplant 92, and a delivery conduit 100 coupled to the couplant reservoir 98 and coupled to the transducer fixture 26, thereby to provide fluid flow between the couplant reservoir 98 and the couplant recess 54. In some embodiments, as shown in FIGS. 6A and 6B, the couplant supply apparatus 90 further may include a couplant valve 102 between the couplant reservoir 98 and a couplant passage 94 in the transducer fixture 26, and the couplant valve 102 may be configured to open and close to control flow of the couplant 92 to the couplant recess 54.

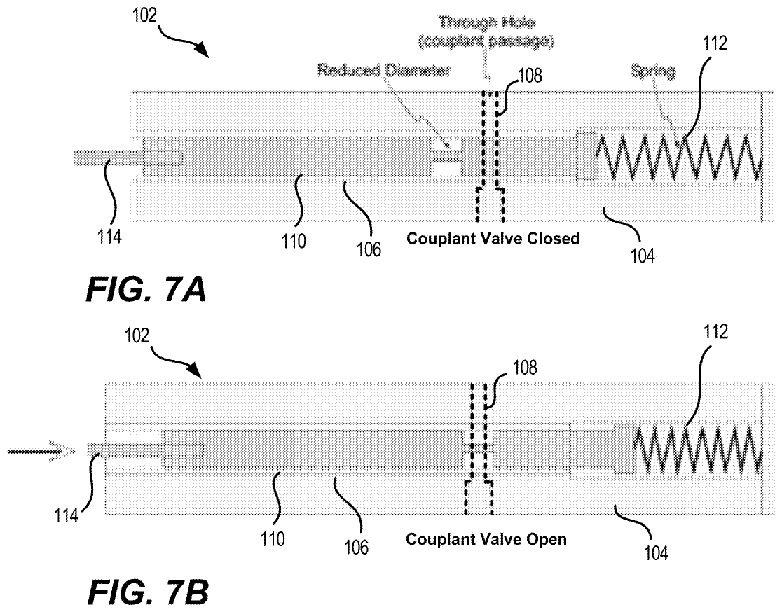

FIG. 7A is a schematic side view of an example couplant valve 102 in an example closed condition, according to embodiments of the disclosure, and FIG. 7B is a schematic side view of the example couplant valve 102 shown in FIG. 7A in an example open condition, according to embodiments of the disclosure. As shown, in some embodiments, the couplant valve 102 may include a housing 104 between the delivery conduit 100 and the couplant passage 94 of the transducer fixture 26. The housing 104 may be coupled to the rear side of transducer fixture 26 (e.g., the fixture rear 52, FIG. 2A). The housing 104 may define a tubular receiver 106 extending along a longitudinal axis of the housing 104, and a fluid passage 108 transverse relative to the longitudinal axis. The couplant valve 102 also may include a valve body 110 extending in the tubular receiver 106 and configured to reciprocate longitudinally relative to the housing 104 between (a) a closed condition preventing flow of the couplant to the couplant passage 94 and (b) an open condition allowing flow of the couplant to the couplant passage 94. As shown in FIGS. 7A and 7B, in some embodiments, the couplant valve 102 further may include biasing member 112 (e.g., a spring, such as a coil spring) positioned in the housing 104 to bias the valve body 110 to be in the closed condition. The couplant valve 102 also may include a follower 114 coupled to a first end of the valve body 110 and configured to follow contours of the component 12 during inspection and cause the valve body 110 to move to the open condition when the fixture base 46 approaches the component 12, for example, when the fixture base 46 contacts the component 12.

As shown in FIGS. 7A and 7B, the valve body 110 may include a longitudinal axis substantially parallel to the longitudinal axis of the housing 104, and the valve body 110 may include a flow passage 116 transverse to (e.g., perpendicular to) the longitudinal axis of the valve body 110 and positioned to be (a) substantially aligned with the fluid passage 108 of the housing 104 when the valve body 110 is in the open condition and (b) substantially misaligned with the fluid passage 108 of the housing 104 when the valve body 110 is in the closed condition.

In some embodiments, gravity and capillary forces may provide a feeding mechanism for supplying the couplant 92 to the couplant recess 54. Without any control over the flow, however, the couplant 92 may flow continuously to the couplant recess 54 of the transducer fixture 26. This continuous flow of the couplant 92 may be undesirable for many inspection circumstances, for example, because the amount of couplant 92 in the couplant reservoir 98 is limited, and flooding surrounding areas where the inspection is being performed may be problematic. In some embodiments, to control the flow of the couplant 92 during a stand-by mode, the couplant valve 102 may be provided.

As shown in FIG. 6A, the couplant valve 102 is in the closed condition, with the flow passage 116 of the valve body 110 being misaligned with the fluid passage 108 of the housing 104, and hence none of the couplant 92 flows to the couplant recess 54 of the transducer fixture 26. During an inspection mode, for example, as schematically depicted in FIG. 6B, the follower 114 is placed in contact with the surface of the component 12, and the valve body 110 is pushed against the biasing member 112, so that the flow passage 116 of the valve body 110 is substantially aligned with the fluid passage 108 of the housing 104, and hence the couplant 92 flows to the couplant recess 54 of the transducer fixture 26. In some embodiments, once the couplant 92 flows to the couplant recess 54, a small gap between the fixture base 46 and the surface of component 12 is filled with couplant 92 via capillary action and held in place.

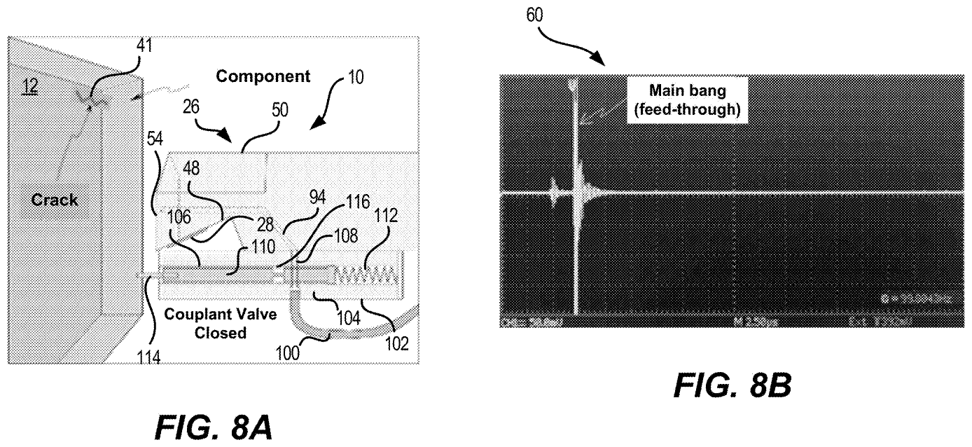

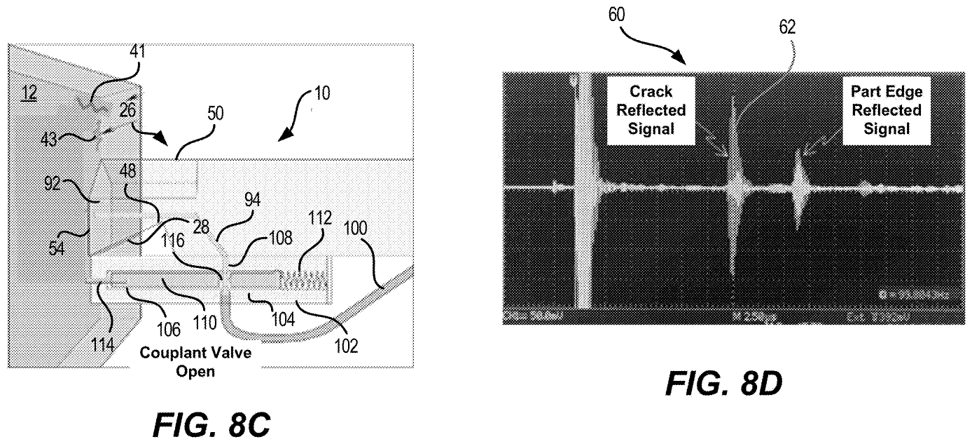

FIG. 8A is a schematic perspective view of an example crack detection assembly 10, including an example transducer fixture 26 and example transducer 28, separated from an example surface of an example component 12 for inspection prior to beginning inspection of the component 12, according to embodiments of the disclosure. FIG. 8B is a schematic view of an example display device 60 depicting an example representation 62 of an example return signal 44′ received by the transducer 28 of FIG. 8A for an example component 12 for inspection prior to beginning inspection of the component 12, according to embodiments of the disclosure. FIG. 8C is a schematic perspective view of the example crack detection assembly 10 shown in FIG. 8A after the example transducer fixture 26 and transducer 28 have approached and contacted the surface of the component 12 (e.g., via the couplant 92 and/or directly) for inspection once the inspection of the component 12 has commenced, according to embodiments of the disclosure. FIG. 8D is a schematic view of the example display device 60 depicting an example representation 62 of an example return signal 44′ received by the transducer 28 of FIG. 8C for an example component 12 having a surface irregularity or flaw, such as a crack 41, according to embodiments of the disclosure.

As shown in FIGS. 6A, 6B, 8A, and 8C, according to some embodiments, the housing 104 of the couplant valve 102 is coupled to the transducer fixture 26 (either directly as shown or indirectly), such that (a) a first end of the valve body 110 protrudes from the housing 104 beyond a plane substantially defined by the fixture base 46 when the crack detection assembly 10 is spaced from the component 12, and the valve body 110 is in the closed condition, and (b) the valve body 110 is depressed longitudinally into the housing 104, such that the first end of the valve body 110 is substantially aligned with the plane substantially defined by the fixture base 46 when the fixture base 46 approaches the component 12 (e.g., contacts the component 12), thereby to longitudinally move the valve body 110 to cause the valve body 110 to be in the open condition, such that the fluid passage 108 of the housing is substantially aligned with the flow passage 116 of the valve body 110, thereby to allow couplant 92 to flow through the couplant valve 102 from the couplant reservoir 98 to the couplant recess 54 of the transducer fixture 26.

As shown in FIGS. 8A-8D, according to some embodiments, during an example stand-by mode, as depicted in FIG. 8A, no indications of reflected signals 44′, except the main bang (feed-through) signal, is shown on the example display device 60, as shown in FIG. 8B. In contrast, FIG. 8C depicts an example inspection mode condition with the transducer fixture 26 and transducer 28 positioned toward the surface of the component 12. Once the gap between the transducer fixture 26 and transducer 28 and surface of the component 12 is reduced or substantially eliminated, with couplant 92 in the couplant recess 54, reflected signals 44 of both the crack 41 (and component edge) appear in the example display device 60, as shown in FIG. 8D.

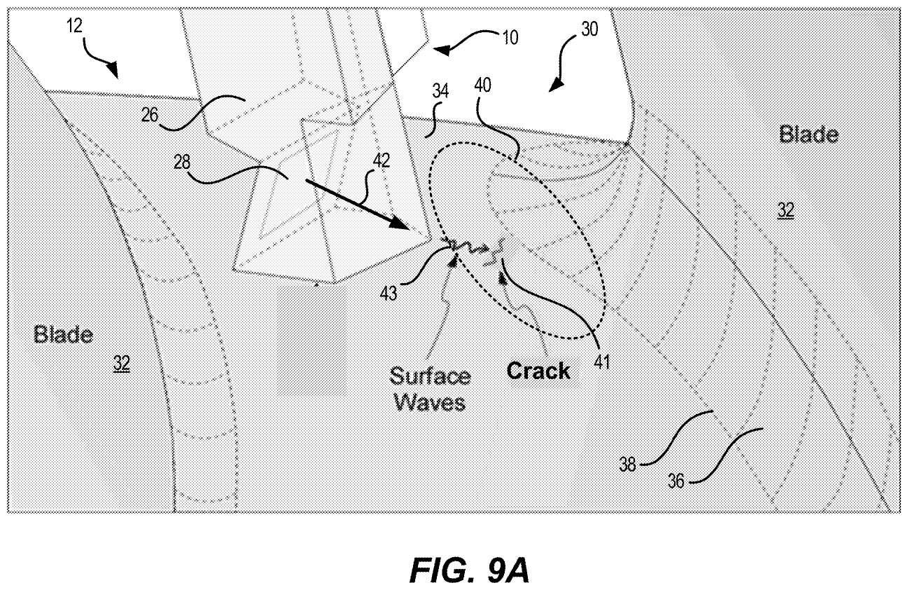

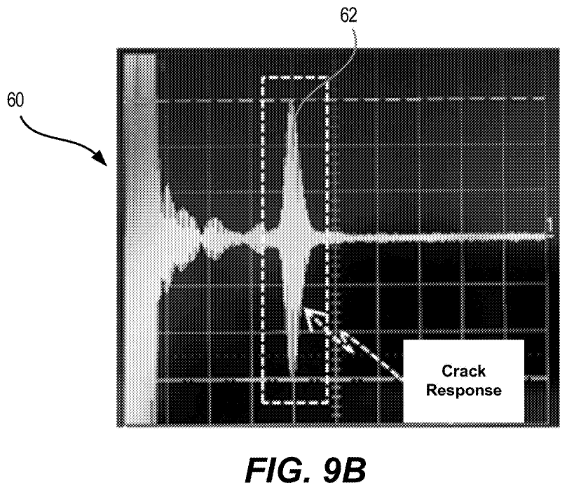

FIG. 9A is a schematic perspective view diagrammatically illustrating an example transducer fixture 26 and example transducer 28 travelling along another example contoured surface of another example component 12, with the transducer 28 emitting an example ultrasonic signal 42 toward an example target inspection area 40, according to embodiments of the disclosure. For example, the transducer 28 may be configured to emit an ultrasonic signal 42 toward and/or into the surface of component 12, for example, in a direction generally toward a target inspection area 40 of the component 12 in order to detect component irregularities and/or flaws, such as the example crack 41. The ultrasonic signal 42 may result in a mode-converted surface wave signal 43 traveling in the general direction toward the target inspection area 40. FIG. 9B is a schematic view of an example display device 60 depicting an example representation 62 of an example return signal 44′ received by the transducer 28 of FIG. 9A for an example component 12 having a surface irregularity or flaw, such as a crack 41, according to embodiments of the disclosure. For example, with the emitted ultrasonic surface wave signals 43, the transducer fixture 26 and the transducer 28 may be positioned on a relatively flat surface away from a contoured area, for example, as schematically depicted in FIG. 9A. Upon interacting with the crack 41, a reflection occurs and may be detected by the same piezoelectric element on the transducer 28 (and/or by another receiver), for example, as schematically depicted in FIG. 9B, which shows an example display device 60 depicting an example representation 62 of an example return signal 44′ received by the transducer 28 of FIG. 9A.

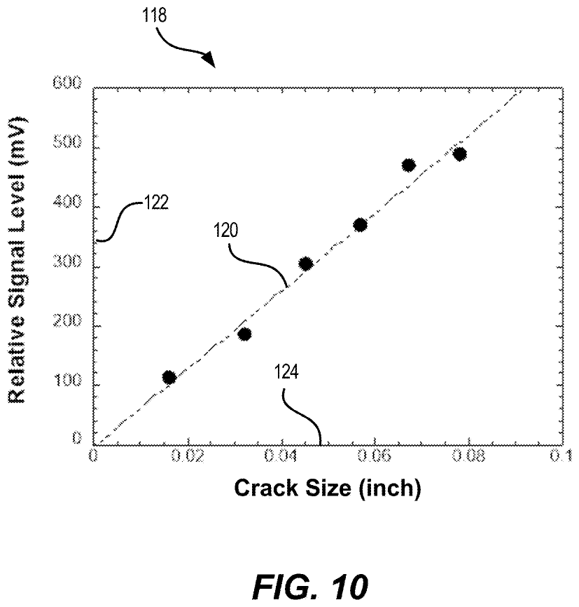

FIG. 10 is a graph 118 showing an example correlation 120 between relative return signal level 122 and crack size 124, according to embodiments of the disclosure. For example, in some embodiments, the levels (e.g., amplitudes) of the reflected signals 44′ (e.g., crack-reflected waves) may be correlated to the dimensions of the crack 41. For example, the larger the crack 41, the stronger the reflected signals 44′. In such embodiments, the levels of the reflected signals 44′ may be used to estimate or determine, for example, a crack width and/or a crack depth.

FIG. 11 is a block diagram of an example electrical assembly 126 for an example crack detection assembly 10, including a control circuit 128 for providing power and control to an example transducer 28, according to embodiments of the disclosure. For example, in some embodiments, the crack detection assembly 10 may include a detection assembly controller 130 in signal communication with the ultrasonic transducer 28, and the detection assembly controller 130 may be configured to electrically drive the ultrasonic transducer 28 and receive the return signal 44′. In some embodiments, the detection assembly controller 130 may include one or more of a power supply 132 configured to activate the ultrasonic transducer 28, a pulse driver 134 configured to cause the ultrasonic transducer 28 to emit the ultrasonic signal 42, a drive/receive switch 136 configured to drive the ultrasonic transducer 28 and receive the return signal 44′, or a signal amplifier 138 configured to receive and amplify the return signal 44′. As shown, the crack detection assembly 10 further may include a communication interface 140 configured to facilitate communication between a digital scanner 142 and the drive/receive switch 136.

As shown in FIG. 11, in some embodiments, the control circuit 128 may include a custom-designed printed circuit board (PCB) that may be designed to drive the transducer 28 (e.g., a piezoelectric element) on the transducer fixture 26, and receive/amplify the crack-reflected signal (e.g., the reflected signals 44′), for example, as described herein. The PCB may not only fit in an electrical housing of the crack detection assembly 10 (e.g., in the transducer fixture 26 or the electrical housing 18), but may also interconnect with the digital scanner 142 that may be equipped with an existing inspection robotic mechanism (e.g., the robotic mechanism 14). The sequence of pulsing and receiving may be controlled, at least in part, via an onboard PIC microprocessor 144, for example, as shown in FIG. 11. In some embodiments, the electrical assembly 126 further may include a digital conversion for timing control unit 146 in communication with the PIC microprocessor 144. The electrical assembly 126 also may include a a probe interface 148 to facilitate communication between the digital scanner 142 and the control circuit 128.

In some embodiments, two control signals may be generated and used to drive the transducer 28 and to receive crack-reflected surface wave signals. For example, as shown in FIG. 11, the probe power (e.g., +13 VDC), a 5 MHz sinusoidal signal, and/or custom I/O signals may be supplied to the PCB through a probe interface. The input probe power of +13 VDC may be converted by the onboard power supply to suitable onboard power levels: −5 VDC, +5 VDC, and +3.3 VDC, for example. The input probe power of may also be used to generate, for example, +80 VDC/+120 VDC, as the drive pulse. The PIC microprocessor 144 may be used to monitor power levels, communicate with the scanner, and/or provide general-purpose I/O signals to control the pulse width and the electronic gate window for the received signal(s). The repetition rate of the drive pulse may be controlled by the microprocessor timing control signal. A digital output from the microprocessor may be used, for example, to control the RF switch. The drive pulse(s) may be fed to the piezoelectric element (e.g., the transducer 28) on the transducer fixture 26. The reflected surface wave signal(s) from a fatigue crack may be received by the same piezoelectric element, for example, with a time delay. The received signal(s) may pass through the RF switch and may be amplified before it passes back to the digital scanner via the probe interface.

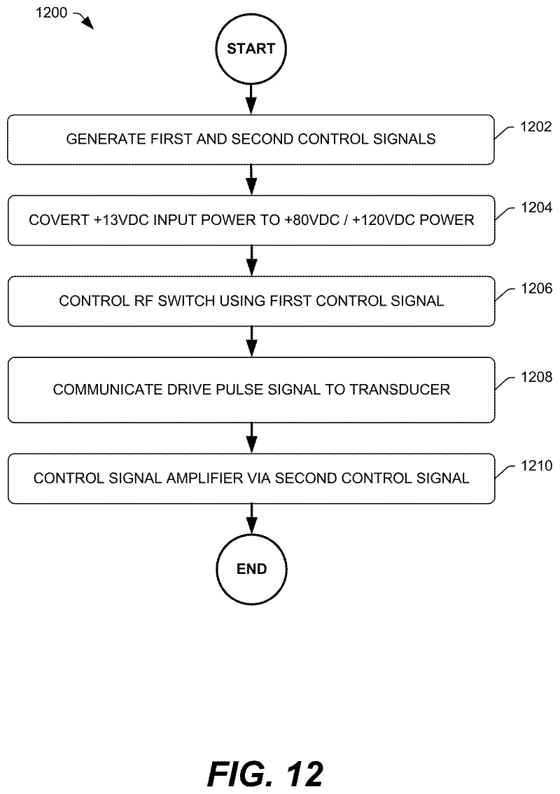

FIG. 12 is an example block diagram of an example process 1200 for operating an example crack detection assembly 10, according to embodiments of the disclosure, illustrated as a collection of blocks in a logical flow graph, which represents a sequence of operations. For the example method 1200, the order in which the operations are described is not intended to be construed as a limitation, and any number of the described blocks may be combined in any order and/or in parallel to implement the method 1200.

The example method 1200, at 1202, may include generating first and second control signals, for example, as described herein. At 1204, the example method 1200 further may include converting +13 VDC input power to +80 VDC/+120 VDC power. The example method 1200 also may include, at 1206, controlling the RF switch via the first control signal. At 1208, the example method 1200 further may include communicating a drive pulse to the transducer (e.g., a piezoelectric element). The example method 1200, at 1210, also may include controlling the receive signal via the second control signal.

A method for automated non-destructive inspection of a component may include emitting via a transducer an ultrasonic signal toward a surface of the component at an oblique angle relative to the surface of the component, for example, as described herein. The method further may include passing the ultrasonic signal through a transducer fixture configured to at least partially collimate the ultrasonic signal, for example, as described herein. The method also may include receiving via the transducer a return signal reflected from the surface of the component, and determining, based at least in part on the return signal, whether a crack exists in the surface of the component, for example, as described herein. In some embodiments, the method for inspection further may include determining, based at least in part on the return signal, one or more of a depth of the crack or a width of the crack, for example, as described herein. In some embodiments of the method of inspection, the passing of the ultrasonic signal through a transducer fixture may include passing the ultrasonic signal through a surface of the transducer fixture having a V-shaped cross-section, thereby to at least partially collimate the ultrasonic signal, for example, as described herein.

In some embodiments, the method for inspection further may include supplying couplant to the surface of the component, thereby to enhance one or more of an accuracy or a consistency of the determining of whether a crack exists in the surface of the component, for example, as described herein. For example, the supplying of the couplant to the surface of the component may include moving the transducer fixture so that it approaches the surface of the component, for example, as described herein. In some embodiments of the method, the transducer fixture may at least partially define a couplant recess, and the supplying of the couplant to the surface of the component may include supplying the couplant to the couplant recess, for example, as described herein. In some embodiments, the method for inspection further may include controlling the supplying of the couplant to the couplant recess via operation of a couplant valve, for example, as described herein. For example, the controlling may include closing the couplant valve to prevent the supplying of the couplant to the couplant recess when the transducer fixture is separated from the surface of the component, and opening the couplant valve to supply the couplant to the couplant recess when the transducer fixture approaches the surface of the component.

In some embodiments, the method for inspection further may include controlling movement of the transducer fixture relative to the surface of the component via operation of a robotic mechanism, for example, as described herein. For example, the controlling of movement of the transducer fixture relative to the surface of the component may be at least partially automatically controlled. In some embodiments, the method of inspection also may include displaying, via a display device, a representation of the return signal.

In some embodiments, the method for inspection also may include supplying power to an ultrasonic transducer configured to emit the ultrasonic signal, causing, via a pulse driver electrically connected to the ultrasonic transducer, the ultrasonic transducer to emit the ultrasonic signal. The method further may include receiving, via a drive/receive switch, the return signal, and amplifying the return signal, for example, as described herein.

In examples, provided are:

A. A crack detection assembly for automated non-destructive inspection of a component, the crack detection assembly comprising: an ultrasonic transducer configured to emit an ultrasonic signal into a surface of the component and receive a return signal reflected from the surface of the component; a transducer fixture coupled to the ultrasonic transducer, the transducer fixture being substantially transparent to the ultrasonic signal and the return signal, the transducer fixture comprising: a fixture base, the fixture base being substantially planar and configured to approach the surface of the component when emitting the ultrasonic signal and receiving the return signal; a fixture transducer mount, the ultrasonic transducer being coupled to the fixture transducer mount, such that the ultrasonic signal is emitted at a mount angle relative to the fixture base, the mount angle being oblique relative to the fixture base; and a fixture front face extending away from the fixture base, the fixture front face having a cross-section substantially parallel to the fixture base, the cross-section being at least partially V shaped, thereby to at least partially collimate the ultrasonic signal.

B. The crack detection assembly of paragraph A, wherein the mount angle ranges from about 45 degrees to about 80 degrees.

C. The crack detection assembly of paragraph A, wherein the cross-section at least partially defines an angle ranging from about 100 degrees to about 160 degrees.

D. The crack detection assembly of paragraph A, wherein the fixture transducer mount is associated with a fixture rear substantially opposite the fixture front face, the fixture rear extending obliquely away from the fixture base.

E. The crack detection assembly of paragraph A, wherein the transducer fixture further comprises a couplant recess in the fixture base, the couplant recess having a recess perimeter and a recess depth, the couplant recess being configured to receive couplant therein, the recess depth at least partially defining a couplant thickness.

F. The crack detection assembly of paragraph A, wherein the fixture front face is opposite the fixture transducer mount and extends away from the fixture base at a front face angle ranging from about 70 degrees to about 110 degrees.

G. The crack detection assembly of paragraph A, wherein the ultrasonic transducer comprises a piezoelectric element, the piezoelectric element including a wafer at least partially defined by: a first side, a second side opposite the first side, and four edges at a perimeter of the wafer, the first side having a first conducting coating and the second side having a second conducting coating, three of the four edges being substantially devoid of conducting coating, and a fourth edge of the four edges having a conducting coating tab extending from the first side, traversing the fourth edge, and onto the second side, the conducting coating tab being spaced from the second conducting coating.

H. The crack detection assembly of paragraph G, further comprising a first conductor attached to the conducting coating tab and a second conductor attached to the second conducting coating along an edge of the second side opposite the conducting coating tab, the first and second conductors being configured to be electrically connected to a transducer control circuit.

I. The crack detection assembly of paragraph G, wherein the piezoelectric element is coupled to the fixture transducer mount with the first side facing into the transducer fixture and generally toward the front face and the fixture base at the mount angle.

J. The crack detection assembly of paragraph A, wherein the transducer fixture further comprises a couplant recess in the fixture base, the crack detection assembly further comprising a couplant supply apparatus coupled to the transducer fixture and configured to supply the couplant to the couplant recess.

K. The crack detection assembly of paragraph J, wherein the transducer fixture at least partially defines therein a couplant passage between a surface of the transducer fixture and the couplant recess, the couplant passage providing fluid flow between the couplant supply apparatus and the couplant recess.

L. The crack detection assembly of paragraph J, wherein the couplant supply apparatus comprises: a couplant reservoir configured to contain a supply of the couplant; a delivery conduit coupled to the couplant reservoir and coupled to the transducer fixture, thereby to provide fluid flow between the couplant reservoir and the couplant recess; and a couplant valve between the couplant reservoir and a couplant passage in the transducer fixture, the couplant valve being configured to open and close to control flow of the couplant to the couplant recess.

M. The crack detection assembly of paragraph L, wherein: the transducer fixture at least partially defines therein a couplant passage between a surface of the transducer fixture and the couplant recess; and the couplant valve comprises: (a) a housing between the delivery conduit and the couplant passage, the housing being coupled to a rear side of transducer fixture, the housing defining: a tubular receiver extending along a longitudinal axis of the housing, and a fluid passage transverse relative to the longitudinal axis; and (b) a valve body extending in the tubular receiver and configured to reciprocate longitudinally relative to the housing between (1) a closed condition preventing flow of the couplant to the couplant passage and (2) an open condition allowing flow of the couplant to the couplant passage.

N. The crack detection assembly of paragraph M, wherein the valve body comprises: a longitudinal axis substantially parallel to a longitudinal axis of the housing; and a flow passage transverse to the longitudinal axis of the valve body and positioned to be (a) substantially aligned with the fluid passage of the housing when the valve body is in the open condition and (b) substantially misaligned with the fluid passage of the housing when the valve body is in the closed condition.

O. The crack detection assembly of paragraph N, wherein the housing is coupled to the transducer fixture, such that: a first end of the valve body protrudes from the housing beyond a plane substantially defined by the fixture base when the crack detection assembly is spaced from the component, and the valve body is in the closed condition, and the valve body is depressed longitudinally into the housing, such that the first end of the valve body is substantially aligned with the plane substantially defined by the fixture base when the fixture base approaches the component, thereby to longitudinally move the valve body to cause the valve body to be in the open condition, such that the fluid passage of the housing is substantially aligned with the flow passage of the valve body, thereby to allow couplant to flow through the couplant valve from the couplant reservoir to the couplant recess.

P. The crack detection assembly of paragraph M, wherein couplant valve further comprises biasing member positioned in the housing to bias the valve body to be in the closed condition.

Q. The crack detection assembly of paragraph M, further comprising a follower coupled to a first end of the valve body and configured to follow contours of the component and cause the valve body to move to the open condition when the fixture base approaches the component.

R. The crack detection assembly of paragraph A, further comprising a robotic mechanism coupled to the transducer fixture and configured to control movement of the transducer fixture over a surface of the component during operation of the crack detection assembly.

S. The crack detection assembly of paragraph A, further comprising a display device in signal communication with the ultrasonic transducer, the display device being configured to depict a representation of the return signal.

T. The crack detection assembly of paragraph A, further comprising a detection assembly controller in signal communication with the ultrasonic transducer, the detection assembly controller being configured to electrically drive the ultrasonic transducer and receive the return signal.

U. The crack detection assembly of paragraph T, wherein the detection assembly controller comprises: a power supply configured to activate the ultrasonic transducer; a pulse driver configured to cause the ultrasonic transducer to emit the ultrasonic signal; a drive/receive switch configured to drive the ultrasonic transducer and receive the return signal; and a signal amplifier configured to receive and amplify the return signal.

V. The crack detection assembly of paragraph U, further comprising a communication interface configured to facilitate communication between a digital scanner and the drive/receive switch.

W. A crack detection assembly for automated non-destructive inspection of a component, the crack detection assembly comprising: (a) an ultrasonic transducer configured to emit an ultrasonic signal into a surface of the component and receive a return signal reflected from the surface of the component, the ultrasonic transducer comprising a piezoelectric element, the piezoelectric element including a wafer at least partially defined by: a first side, a second side opposite the first side, and four edges at a perimeter of the wafer, the first side having a first conducting coating and the second side having a second conducting coating, three of the four edges being substantially devoid of conducting coating, and a fourth edge of the four edges having a conducting coating tab extending from the first side, traversing the fourth edge, and onto the second side, the conducting coating tab being spaced from the second conducting coating; and (b) a transducer fixture coupled to the ultrasonic transducer, the transducer fixture being substantially transparent to the ultrasonic signal and the return signal.

X. The crack detection assembly of paragraph W, further comprising a first conductor attached the conducting coating tab and a second conductor attached to the second conducting coating along an edge of the second side opposite the conducting coating tab, the first and second conductors being configured to be electrically connected to a transducer control circuit.

Y. The crack detection assembly of paragraph X, wherein the piezoelectric element is coupled to the fixture transducer mount with the first side facing into the fixture transducer mount a mount angle relative to a fixture base of the transducer fixture ranging from about 45 degrees to about 80 degrees.

Z. A crack detection assembly for automated non-destructive inspection of a component, the crack detection assembly comprising: an ultrasonic transducer configured to emit an ultrasonic signal into a surface of the component and receive a return signal reflected from the surface of the component; a transducer fixture coupled to the ultrasonic transducer, the transducer fixture being substantially transparent to the ultrasonic signal and the return signal; and a couplant supply apparatus coupled to the transducer fixture and configured to supply couplant to the transducer fixture, the couplant supply apparatus comprising: a couplant reservoir configured to contain a supply of the couplant, and a couplant valve between the couplant reservoir and a couplant passage at least partially defined by the transducer fixture, the couplant valve being configured to open and close to control flow of the couplant to the transducer fixture.

AA. The crack detection assembly of paragraph Z, wherein the transducer fixture at least partially defines therein a couplant recess and the couplant passage extends between a surface of the transducer fixture and the couplant recess, the couplant passage providing fluid flow between the couplant supply apparatus and the couplant recess.

AB. The crack detection assembly of paragraph AA, wherein the couplant supply apparatus further comprises a delivery conduit coupled to the couplant reservoir and coupled to the transducer fixture, thereby to provide fluid flow between the couplant reservoir and the couplant recess.

AC. The crack detection assembly of paragraph AB, wherein the couplant valve comprises: (a) a housing between the delivery conduit and the couplant passage, the housing being coupled to a rear side of transducer fixture, the housing defining: a tubular receiver extending along a longitudinal axis of the housing, and a fluid passage transverse relative to the longitudinal axis; and (b) a valve body extending in the tubular receiver and configured to reciprocate longitudinally relative to the housing between (1) a closed condition preventing flow of the couplant to the couplant passage and (2) an open condition allowing flow of the couplant to the couplant passage.

AD. The crack detection assembly of paragraph AC, wherein the valve body comprises:
a longitudinal axis substantially parallel to a longitudinal axis of the housing; and a flow passage transverse to the longitudinal axis of the valve body and positioned to be (a) substantially aligned with the fluid passage of the housing when the valve body is in the open condition and (b) substantially misaligned with the fluid passage of the housing when the valve body is in the closed condition.

AE. The crack detection assembly of paragraph AC, wherein the housing is coupled to the transducer fixture, such that: a first end of the valve body protrudes from the housing beyond a plane substantially defined by the transducer fixture when the crack detection assembly is spaced from the component, and the valve body is in the closed condition, and the valve body is depressed longitudinally into the housing, such that the first end of the valve body is substantially aligned with the plane substantially defined by the transducer fixture when the fixture base approaches the component, thereby to longitudinally move the valve body to cause the valve body to be in the open condition, such that the fluid passage of the housing is substantially aligned with the flow passage of the valve body, thereby to allow couplant to flow through the couplant valve from the couplant reservoir to the couplant recess.

AF. The crack detection assembly of paragraph AC, wherein couplant valve further comprises biasing member positioned in the housing to bias the valve body to be in the closed condition.

AG. The crack detection assembly of paragraph AC, further comprising a follower coupled to a first end of the valve body and configured to follow contours of the component and cause the valve body to move to the open condition when the fixture base approaches the component.

AH. A transducer fixture for a crack detection assembly for automated non-destructive inspection of a component, the transducer fixture comprising: a fixture body comprising a fixture material substantially transparent to ultrasonic signals; a fixture base, the fixture base being substantially planar and configured to approach the surface of a component when emitting the ultrasonic signal and receiving the return signal; a fixture transducer mount configured to be coupled an ultrasonic transducer, such that an ultrasonic signal emitted by an ultrasonic ransducer coupled to the fixture transducer mount is emitted in a direction oblique relative to the fixture base; and a fixture front face extending away from the fixture base, the fixture front face having a cross-section substantially parallel to the fixture base, the cross-section being V shaped, thereby to at least partially collimate the ultrasonic signal.

AI. The transducer fixture of paragraph AH, wherein the direction ranges from about 45 degrees to about 80 degrees relative to the fixture base.

AJ. The transducer fixture of paragraph AH, wherein the cross-section at least partially defines an angle ranging from about 100 degrees to about 160 degrees.

AK. The transducer fixture of paragraph AH, wherein the fixture transducer mount is associated with a fixture rear substantially opposite the fixture front face, the fixture rear extending obliquely away from the fixture base.

AL. The transducer fixture of paragraph AH, wherein the transducer fixture further comprises a couplant recess in the fixture base, the couplant recess having a recess perimeter and a recess depth, the couplant recess being configured to receive couplant therein, the recess depth at least partially defining a couplant thickness.

AM. The transducer fixture of paragraph AH, wherein the transducer fixture at least partially defines therein a couplant passage between a surface of the transducer fixture and the couplant recess, the couplant passage configured to provide fluid flow between a supply of couplant and the couplant recess.

AN. The transducer fixture of paragraph AH, wherein the fixture front face is opposite the fixture transducer mount and extends away from the fixture base at a front face angle ranging from about 70 degrees to about 110 degrees.

AO. A piezoelectric transducer for a crack detection assembly for automated non-destructive inspection of a component, the piezoelectric transducer comprising: a wafer at least partially defined by: a first side, a second side opposite the first side, and four edges at a perimeter of the wafer, a first conducting coating on the first side; a second conducting coating on the second side, three of the four edges being substantially devoid of conducting coating; and a conducting coating tab on a fourth edge of the four edges, the conducting coating tab extending from the first conducting coating on the first side, traversing the fourth edge, and extending onto the second side, and the conducting coating tab being spaced from the second conducting coating on the second side.

AP. The piezoelectric transducer of paragraph AO, further comprising: a first contact point on conducting coating tab, the first contact point being configured to be electrically connected to a first conductor; and a second contact point on the second conducting coating along an edge of the second side opposite the conducting coating tab, the second contact point being configured to be electrically connected to a second conductor.

AQ. The piezoelectric transducer of paragraph AP, wherein the first side of the wafer is configured to be coupled to a fixture transducer mount, such that the conducting coating tab and the second conducting coating face away from the fixture transducer mount.

AR. A couplant supply apparatus for supplying couplant to a crack detection assembly for automated non destructive inspection of a component, the couplant supply apparatus comprising: a couplant reservoir configured to contain a supply of the couplant; a delivery conduit coupled to the couplant reservoir and configured to be coupled to a transducer fixture, thereby to provide fluid flow between the couplant reservoir and the transducer fixture; and a couplant valve between the couplant reservoir and a couplant passage in the transducer fixture, the couplant valve being configured to open and close to control flow of the couplant to the couplant recess.

AS. The couplant supply apparatus of paragraph AR, wherein the couplant valve comprises: (a) a housing configured to be coupled to the transducer fixture, the housing defining: a tubular receiver extending along a longitudinal axis of the housing, and a fluid passage transverse relative to the longitudinal axis; and (b) a valve body extending in the tubular receiver and configured to reciprocate longitudinally relative to the housing between (1) a closed condition preventing flow of the couplant to the transducer fixture and (2) an open condition allowing flow of the couplant to the transducer fixture.

AT. The couplant supply apparatus of paragraph AS, wherein the valve body comprises: a longitudinal axis substantially parallel to a longitudinal axis of the housing; and a flow passage transverse to the longitudinal axis of the valve body and positioned to be: (a) substantially aligned with the fluid passage of the housing when the valve body is in the open condition and (b) substantially misaligned with the fluid passage of the housing when the valve body is in the closed condition.

AU. The couplant supply apparatus of paragraph AT, wherein: the housing is configured to be coupled to the transducer fixture, such that: (a) a first end of the valve body protrudes from the housing beyond a plane substantially defined by the transducer fixture when the crack detection assembly is spaced from the component, and the valve body is in the closed condition, and (b) the valve body is depressed longitudinally into the housing, such that the first end of the valve body is substantially aligned with the plane substantially defined by the transducer fixture when the crack detection assembly approaches the component, thereby to longitudinally move the valve body to the open condition, such that the fluid passage of the housing is substantially aligned with the flow passage of the valve body, thereby to allow couplant to flow through the couplant valve from the couplant reservoir to the transducer fixture.

AV. The couplant supply apparatus of paragraph AS, wherein couplant valve further comprises biasing member positioned in the housing to bias the valve body to be in the closed condition.

AW. The couplant supply apparatus of paragraph AS, further comprising a follower coupled to a first end of the valve body and configured to follow contours of the component and cause the valve body to move to the open condition when the transducer fixture approaches the component.

AX. A method for automated non-destructive inspection of a component, the method comprising: emitting via a transducer an ultrasonic signal toward a surface of the component at an oblique angle relative to the surface of the component; passing the ultrasonic signal through a transducer fixture configured to at least partially collimate the ultrasonic signal; receiving via the transducer a return signal reflected from the surface of the component; and determining, based at least in part on the return signal, whether a crack exists in the surface of the component.

AY. The method of paragraph AX, further comprising determining, based at least in part on the return signal, one or more of a depth of the crack or a width of the crack.

AZ. The method of paragraph AX, wherein the passing of the ultrasonic signal through a transducer fixture comprises passing the ultrasonic signal through a surface of the transducer fixture having a V-shaped cross-section, thereby to at least partially collimate the ultrasonic signal.

BA. The method of paragraph AX, further comprising supplying couplant to the surface of the component, thereby to enhance one or more of an accuracy or a consistency of the determining of whether a crack exists in the surface of the component.

BB. The method of paragraph BA, wherein the supplying of the couplant to the surface of the component comprises moving the transducer fixture so that it approaches the surface of the component.

BC. The method of paragraph BA, wherein the transducer fixture at least partially defines a couplant recess, and the supplying of the couplant to the surface of the component comprises supplying the couplant to the couplant recess.

BD. The method of paragraph BC, further comprising controlling the supplying of the couplant to the couplant recess via operation of a couplant valve.

BE. The method of paragraph BD, wherein the controlling comprises: closing the couplant valve to prevent the supplying of the couplant to the couplant recess when the transducer fixture is separated from the surface of the component; and opening the couplant valve to supply the couplant to the couplant recess when the transducer fixture approaches the surface of the component.

BF. The method of paragraph AX, further comprising controlling movement of the transducer fixture relative to the surface of the component via operation of a robotic mechanism.

BG. The method of paragraph BF, wherein the controlling of movement of the transducer fixture relative to the surface of the component is at least partially automatically controlled.

BH. The method of paragraph AX, further comprising displaying, via a display device, a representation of the return signal.

BI. The method paragraph AX, further comprising: supplying power to an ultrasonic transducer configured to emit the ultrasonic signal; causing, via a pulse driver electrically connected to the ultrasonic transducer, the ultrasonic transducer to emit the ultrasonic signal; receiving, via a drive/receive switch, the return signal; and amplifying the return signal.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A crack detection assembly for automated non-destructive inspection of a component, the crack detection assembly comprising:
an ultrasonic transducer configured to emit an ultrasonic signal into a surface of the component and receive a return signal reflected from the surface of the component;
a transducer fixture coupled to the ultrasonic transducer, the transducer fixture being substantially transparent to the ultrasonic signal and the return signal, the transducer fixture comprising:
a fixture base, the fixture base being substantially planar and configured to approach the surface of the component when emitting the ultrasonic signal and receiving the return signal;
a fixture transducer mount, the ultrasonic transducer being coupled to the fixture transducer mount, such that the ultrasonic signal is emitted at a mount angle relative to the fixture base, the mount angle being oblique relative to the fixture base; and
a fixture front face extending away from the fixture base, the fixture front face having a cross-section substantially parallel to the fixture base, the cross-section being at least partially V-shaped, thereby to at least partially collimate the ultrasonic signal.

2. The crack detection assembly of claim 1, wherein the mount angle ranges from about 45 degrees to about 80 degrees.

3. The crack detection assembly of claim 1, wherein the cross-section at least partially defines an angle ranging from about 100 degrees to about 160 degrees.

4. The crack detection assembly of claim 1, wherein the fixture transducer mount is associated with a fixture rear substantially opposite the fixture front face, the fixture rear extending obliquely away from the fixture base.

5. The crack detection assembly of claim 1, wherein the transducer fixture further comprises a couplant recess in the fixture base, the couplant recess having a recess perimeter and a recess depth, the couplant recess being configured to receive couplant therein, the recess depth at least partially defining a couplant thickness.

6. The crack detection assembly of claim 1, wherein the fixture front face is opposite the fixture transducer mount and extends away from the fixture base at a front face angle ranging from about 70 degrees to about 110 degrees.

7. The crack detection assembly of claim 1, wherein the ultrasonic transducer comprises a piezoelectric element, the piezoelectric element including a wafer at least partially defined by:
a first side,
a second side opposite the first side, and
four edges at a perimeter of the wafer,
the first side having a first conducting coating and the second side having a second conducting coating, three of the four edges being substantially devoid of conducting coating, and a fourth edge of the four edges having a conducting coating tab extending from the first side, traversing the fourth edge, and onto the second side, the conducting coating tab being spaced from the second conducting coating.

8. The crack detection assembly of claim 7, further comprising a first conductor attached to the conducting coating tab and a second conductor attached to the second conducting coating along an edge of the second side opposite the conducting coating tab, the first and second conductors being configured to be electrically connected to a transducer control circuit.

9. The crack detection assembly of claim 7, wherein the piezoelectric element is coupled to the fixture transducer mount with the first side facing into the transducer fixture and generally toward the front face and the fixture base at the mount angle.

10. The crack detection assembly of claim 1, wherein the transducer fixture further comprises a couplant recess in the fixture base, the crack detection assembly further comprising a couplant supply apparatus coupled to the transducer fixture and configured to supply the couplant to the couplant recess.

11. The crack detection assembly of claim 10, wherein the transducer fixture at least partially defines therein a couplant passage between a surface of the transducer fixture and the couplant recess, the couplant passage providing fluid flow between the couplant supply apparatus and the couplant recess.

12. The crack detection assembly of claim 10, wherein the couplant supply apparatus comprises:
a couplant reservoir configured to contain a supply of the couplant;
a delivery conduit coupled to the couplant reservoir and coupled to the transducer fixture, thereby to provide fluid flow between the couplant reservoir and the couplant recess; and
a couplant valve between the couplant reservoir and a couplant passage in the transducer fixture, the couplant valve being configured to open and close to control flow of the couplant to the couplant recess.

13. The crack detection assembly of claim 12, wherein:
the transducer fixture at least partially defines therein a couplant passage between a surface of the transducer fixture and the couplant recess; and
the couplant valve comprises:
(a) a housing between the delivery conduit and the couplant passage, the housing being coupled to a rear side of transducer fixture, the housing defining:
a tubular receiver extending along a longitudinal axis of the housing, and
a fluid passage transverse relative to the longitudinal axis; and
(b) a valve body extending in the tubular receiver and configured to reciprocate longitudinally relative to the housing between (1) a closed condition preventing flow of the couplant to the couplant passage and (2) an open condition allowing flow of the couplant to the couplant passage.

14. The crack detection assembly of claim 13, wherein the valve body comprises:
a longitudinal axis substantially parallel to a longitudinal axis of the housing; and
a flow passage transverse to the longitudinal axis of the valve body and positioned to be (a) substantially aligned with the fluid passage of the housing when the valve body is in the open condition and (b) substantially misaligned with the fluid passage of the housing when the valve body is in the closed condition.

15. The crack detection assembly of claim 14, wherein the housing is coupled to the transducer fixture, such that:
a first end of the valve body protrudes from the housing beyond a plane substantially defined by the fixture base when the crack detection assembly is spaced from the component, and the valve body is in the closed condition, and
the valve body is depressed longitudinally into the housing, such that the first end of the valve body is substantially aligned with the plane substantially defined by the fixture base when the fixture base approaches the component, thereby to longitudinally move the valve body to cause the valve body to be in the open condition, such that the fluid passage of the housing is substantially aligned with the flow passage of the valve body, thereby to allow couplant to flow through the couplant valve from the couplant reservoir to the couplant recess.

16. The crack detection assembly of claim 13, wherein couplant valve further comprises biasing member positioned in the housing to bias the valve body to be in the closed condition.

17. The crack detection assembly of claim 13, further comprising a follower coupled to a first end of the valve body and configured to follow contours of the component and cause the valve body to move to the open condition when the fixture base approaches the component.

18. The crack detection assembly of claim 1, further comprising a robotic mechanism coupled to the transducer fixture and configured to control movement of the transducer fixture over a surface of the component during operation of the crack detection assembly.

19. The crack detection assembly of claim 1, further comprising a display device in signal communication with the ultrasonic transducer, the display device being configured to depict a representation of the return signal.

20. The crack detection assembly of claim 1, further comprising a detection assembly controller in signal communication with the ultrasonic transducer, the detection assembly controller being configured to electrically drive the ultrasonic transducer and receive the return signal.

21. The crack detection assembly of claim 20, wherein the detection assembly controller comprises:
a power supply configured to activate the ultrasonic transducer;
a pulse driver configured to cause the ultrasonic transducer to emit the ultrasonic signal;
a drive/receive switch configured to drive the ultrasonic transducer and receive the return signal; and
a signal amplifier configured to receive and amplify the return signal.

22. The crack detection assembly of claim 21, further comprising a communication interface configured to facilitate communication between a digital scanner and the drive/receive switch.

23. A method for automated non-destructive inspection of a component, the method comprising:
emitting via a transducer an ultrasonic signal toward a surface of the component at an oblique angle relative to the surface of the component;
passing the ultrasonic signal through a transducer fixture configured to at least partially collimate the ultrasonic signal;
receiving via the transducer a return signal reflected from the surface of the component; and
determining, based at least in part on the return signal, whether a crack exists in the surface of the component.
